(19) United States
(12) Patent Application Publication
(10) Pub. No.: US 2012/0158612 A1
(43) Pub. Date: Jun. 21, 2012

(54) System and method for providing financial products

(76) Inventor: Andrew John Robertson, New South Wales (AU)

(21) Appl. No.: 11/920,282

(22) PCT Filed: May 12, 2006
(86) PCT No.: PCT/AU2006/000632

§ 371 Date: Jan. 26, 2009

Related U.S. Application Data
(60) Provisional application No. 60/680,481, filed on May 13, 2005.

(51) Int. Cl. G06Q 40/00

(52) U.S. Cl. 705/36 R; 705/35

(57) ABSTRACT

Disclose are methods, systems and products for providing financial payments to investors who live longer than a specified survival age. Premium payments are received (14) from a plurality of investors. For each investor, a corresponding survival age is established (10, 12, 150). The premium payments are invested to form an investment pool (652) for the investors. An account is maintained that quantifies a respective notional share of the investment pool for each of the investors. If an investor dies, a proportion of the deceased investor's notional share in the investment pool is distributed (104) to the shares of surviving investors of the investment pool. Where a surviving investor is older than the surviving investor's established survival age (110), a survival benefit is paid to the surviving investor, the survival benefit being based (112) upon at least a value of the investment pool. Numerous variations are described for funding the investments, including mortgaging property, as well as determining investment strategies based on mortality risk. Integration with account-based funds is also described.

### CROSS-REFERENCE TO RELATED PATENT APPLICATION

This application claims the right of priority under 35 U.S.C. §119 based on U.S. Patent Application No. 60/680,481, filed May 13, 2005, which is incorporated by reference herein in its entirety as if fully set forth herein.

### FIELD OF THE INVENTION

The present invention relates to financial products and, in particular, to systems and methods for a group of financial instruments. These instruments may separately or in combination provide protection against the financial risk of living past a specified age, release equity locked in home assets, and provide a hedge against long-term annuity liabilities.

### BACKGROUND

A global crisis in retirement income funding is believed to be rapidly approaching. One of the chief drivers is the rapidly swelling number of retirees as the baby boomer population born after the Second World War approaches retirement age. In addition there have been rapid increases in life expectancy in much of the world. Lower retirement ages have pushed the average time in retirement beyond 25 to 30 years.

Other factors affecting retirement incomes are the large proportion of many retiree's total wealth tied up in illiquid home equity, and the projected enormous increases in health care and aged care costs, due in part to new technologies, which will drive up the costs of retirement. This applies especially to the later years of retirement.

In addition, although many retirees have inadequate retirement savings, there are increasing expectations regarding retirement lifestyle.

These forces are going to stress public pension systems and force innovation in retirement income products.

Globally, there are two ends of the retirement income product spectrum. On one side are annuity products issued by insurance companies. These are ‘black-box’ type contracts under which the insurer will offer an income stream in return for an upfront premium. In doing so the life insurer typically provides a level of investment performance and mortality rate guarantees. From a consumer point of view, however, there is no clearly identifiable relationship between the premium paid and the value of the income that is ultimately received. Further, the long-term guarantees are extremely expensive and, in order to fund the guarantees, the life insurer must hold significant capital in excess of its best estimates of liabilities and invest in stable long-term asset classes. As a result the income guaranteed is generally quite low. Despite this fact, many life insurance companies and corporations are financially exposed to massive, long-term longevity related liabilities. At present, it is very difficult to find assets to match these long-term liabilities resulting in these companies being required by prudential authorities to hold significant additional capital reserves.

In many countries, account-based retirement income products (called “allocated pensions” in Australia) have taken a dominant market share, displacing annuity products to some extent. Some reasons for this include low interest rates in recent years, and a perceived lack of flexibility and transparency in the ‘black-box’ annuity contracts. The “allocated pension” product arrangement is illustrated in FIG. 10A and allows customers to set their own investment strategy and to monitor the performance of their investment. An investor provides an investment 850 to an allocated pension 852 that has an account structure 854 that enables the investor to monitor the performance of his or her investment. The company issuing the allocated pension 852 is generally an account administrator and gateway to access wholesale funds 856. The allocated pension 852 does not provide guarantees. As a result the expected returns and income generated from these accounts 854 is superior to annuity products. However there is no guarantee that the investor will not outlive his or her savings in the allocated pension 852. In short, the retiree faces the difficult choice between either spending savings conservatively with a significant chance of living poor and dying rich, or spending more aggressively and facing the real chance of outliving his or her savings.

In the event that a retiree does outlive their liquid savings—and increasingly for other consumption reasons—reverse mortgage products are also growing in popularity. These products provide a loan to a retiree secured with a mortgage against the retiree's property. Interest due on the loan is capitalised onto the total value of the loan. Interest due compounds year-on-year and as a result, many advisers and customers believe such products are not “safe”. For example, if a retiree lives in their home for longer than expected it is possible that the amount owed on the loan can increase to the total value of the property.

In the financial services industry of many countries, as shown in FIG. 1A, an investor 1 is offered several types of product, including direct retail products 6, wholesale fund management products 4a and wholesale fund management products 4b offered via a packaging layer 5. Access to all financial products 4a, 4b, 6 is often mediated by an advisor 2. Access to wholesale and packaged products 4a, 4b may be further mediated by a retail administration layer (or administration systems provider) 3. The job of product providers is made more complex by the requirement to serve the needs of all of investors 1, advisers 2 and retail administration layers 3 to ensure commercial success. There is an on-going need for commercially viable financial instruments that provide retirement income and match long-term longevity-related liabilities.

### SUMMARY

As described herein, problems of existing retirement funding arrangements may be addressed through financial products that enable pooling of the uncertainty associated with individual longevity. Risks associated with group longevity are carried by the investors rather than the product provider, enabling financial products to be provided with the prospect of higher investor returns than traditional annuity structures. Also described are innovative methods for delivering the products to customers and advisers and innovations such as investment pool management, stochastic risk reinsurance, and product options which improve the commercial attractiveness of the product.

Finally, products, systems and methods are described for the efficient release of home equity and the management of long-tail longevity risk exposures through longevity risk pooling and securitisation.

In accordance with one aspect of the present disclosure there is provided a method of providing financial payments to investors who live longer than a specified survival age, said method comprising the steps of:

(a) receiving premium payments from a plurality of investors;

(b) establishing, for each investor, a corresponding survival age;

(c) investing the premium payments to form an investment pool for the investors;

(d) maintaining an account that quantifies a respective notional share of the investment pool for each of the investors;

(e) distributing, if an investor dies, a proportion of the deceased investor's notional share in the investment pool to the shares of surviving investors of the investment pool; and

(f) checking whether a surviving investor is older than the surviving investor's established survival age and, if so, paying a survival benefit to the surviving investor, said survival benefit being based upon at least a value of the investment pool.

In accordance with another aspect of the present disclosure there is provided a financial product in which a plurality of investors each make an investment wherein for at least part of the investment, uncertainty associated with individual longevity of the investors is pooled, characterised by risks associated with group longevity of the investors being carried by the investors rather than a provider of the financial product.

In accordance with another aspect of the present disclosure there is provided an individual longevity risk insurance system for providing financial payments to investors who live longer than a specified survival age, said system comprising:

an investment pool arising from premium payments associated with each of a plurality of investors each having a corresponding survival age;

a first distribution process operative where an investor dies in which a predetermined proportion of the deceased investor's notional share in the investment pool is distributed to the notional shares of surviving investors of the investment pool; and

a second distribution process operative where a surviving investor is older than the surviving investor's established survival age in which a portion of the surviving investor's notional share of the investment pool to issue as a survival benefit for a payment period is periodically determined and to the survival benefit is periodically paid to the surviving investor.

In accordance with another aspect of the present disclosure there is provided a method for providing a retirement income for an investor, said method comprising the steps of:

(a) determining a target profile income for the investor;

(b) buying at least two assets, at least one of which is an individual longevity risk insurance (ILRI) product as above and at least one of which is a liquid (non-ILRI) asset; and

(c) generating an income from said assets by first consuming the liquid assets to meet the target profile income and then generating income from the ILRI product.

In accordance with another aspect of the present disclosure there is provided a method of investing monies, said method comprising the steps of:

(a) establishing an investment account for an investor;

(b) receiving at least one of a lump-sum capital contribution and a periodic investment amount into said account; and

(c) allocating and subsequently investing funds in the account to corresponding investments in a plurality of wholesale funds, at least one of the wholesale funds comprising a wholesale individual longevity risk insurance product according to the above.

In accordance with another aspect of the present disclosure there is provided a method of providing financial service for a plurality of entities, said method comprising, for each entity, the steps of:

classifying a risk exposure of the entity in respect of an insurable event;

determining a level of cover based upon the risk exposure and a value of a corresponding premium;

investing the premium in an accumulating investment account in the name of the entity;

where the insurable event occurs for an entity, paying the level of cover to the entity by deducting a proportion of the investment of each participating entity, said proportion being determined by each entity's instantaneous value at risk; and

obtaining from the entity additional investment where a value of the investment account falls below a predetermined value dependant on the assessment of insurance risks faced by the pool; and

the entity withdrawing from the service by cashing the entity's entire account.

In accordance with another aspect of the present disclosure there is provided an investment product in which investors pool interests in assets that can remain illiquid whilst the investors are alive, the pool generating a liquid stream of income for the investors which hedges the investor's risk associated with financing individual longevity by transferring wealth from first ones of the investors who die before remaining ones of the investors. Desirably the product comprises a pool of mortgage contracts over real property characterized in that the contracts each earn income at a rate at least 50 basis points less than the standard market mortgage rate.

In accordance with another aspect of the present disclosure there is provided a method for creating an asset-backed security which generates long term income streams linked to human longevity, the method comprising:

pooling asset-backed mortgage contracts from a plurality of investors, each said investor having an identified survival age, the contracts each having debts becoming due upon death of the corresponding investor, the debts thereby forming a deferred cash flow,

creating a liquid investment pool of funds derived from retained components of cash flows from the pooled mortgages and proceeds of the sale of other components of the cash flow, and

credit enhancing the other components of the cash flows using the liquid pool of funds to replicate a cash flow linked to longevity risk of the investors over a specified period of time.

Other aspects are also disclosed.

### BRIEF DESCRIPTION OF THE DRAWINGS

Embodiments of the invention will now be described with reference to the drawings, in which:

FIG. 1A is a schematic diagram showing an overview of the existing financial services landscape;

FIG. 1B is a flow diagram of a method for providing an Individual Longevity Risk Insurance (ILRI) life policy to an investor;

FIG. 2A is a flow diagram showing further detail of the payment of benefits to the investor in the method of FIG. 1;

FIG. 2B is a flow diagram of a method of iteratively calculating survival benefits in the method of FIG. 2A;

FIG. 3A is a schematic block diagram of a data processing system that may be used to provide and manage the ILRI life policies;

FIG. 3B is a schematic block diagram showing further detail of the database servers in the system of FIG. 3A;

FIG. 4 is a flow diagram illustrating a front-end sales and marketing method for the ILRI product;

FIG. 5 is a schematic diagram of a general-purpose computer that may be used in the system of FIG. 3 to implement the methods described herein;

FIG. 6A is a schematic illustration of a prior art annuity product;

FIG. 6B is a schematic diagram of a prior art allocated pension product;

FIG. 6C is a schematic diagram of the ILRI product;

FIGS. 7A, 7B and 7C illustrate cash flows associated with the products of FIGS. 6A, 6B and 6C, respectively;

FIG. 8 is an example of the calculation of a survival benefit using the method of FIG. 2B;

FIG. 9 is a flow diagram illustrating the operation of an allocated pension investment;

FIG. 10A is a schematic diagram showing the structure of an allocated pension product;

FIG. 10B is a schematic diagram showing the structure of an allocated pension that offers an Individual Longevity Risk Insurance Asset Class (ILRAC) investment option;

FIG. 11 is a flow diagram illustrating interactions between the allocated pension and the provider of the ILRAC in the system of FIG. 10B;

FIGS. 12A and 12B are schematic diagrams illustrating an implementation of the Individual Longevity Risk Products via Superannuation Trusts; and

FIG. 13 is a schematic diagram illustrating cross-trust pooling and mechanisms for an investor in the Individual Longevity Risk Products to change investment strategy.

FIG. 14 illustrates the investment the customer makes into an ILRI product and the benefits they are eligible for

FIG. 15 illustrates improvements achievable in total expected income when a retirement strategy includes ILRI assets in comparison to those that could be achieved without them;

FIG. 16A illustrates both the relationship between the population of ILRI customers and the broader population of retirees and approaches to estimating future mortality of these groups

FIG. 16 B illustrates systematic and stochastic mortality risks experienced by ILRI customers;

FIG. 17A illustrates a mechanism for capping “small numbers” volatility;

FIG. 17B illustrates the reserving structures required to implement small numbers risk smoothing and other guarantees in the context of the ILRI product; and

FIG. 17C is a flow diagram of a method for providing dynamic reserving and mortality model updating for ILRI products;

FIG. 18 is a schematic diagram representing an example of an ILRI funded by a (reverse) mortgage.

### DETAILED DESCRIPTION INCLUDING BEST MODE

An Individual Longevity Risk Insurance (ILRI) product is described herein that enables an individual (typically a retiree or a prospective retiree) to invest a portion of his or her savings in a pooled insurance vehicle. The pooled investments grow at market rates and an income stream (actually a series of survival benefits) is paid from the pooled investments to individual investors who have survived past a specified age.

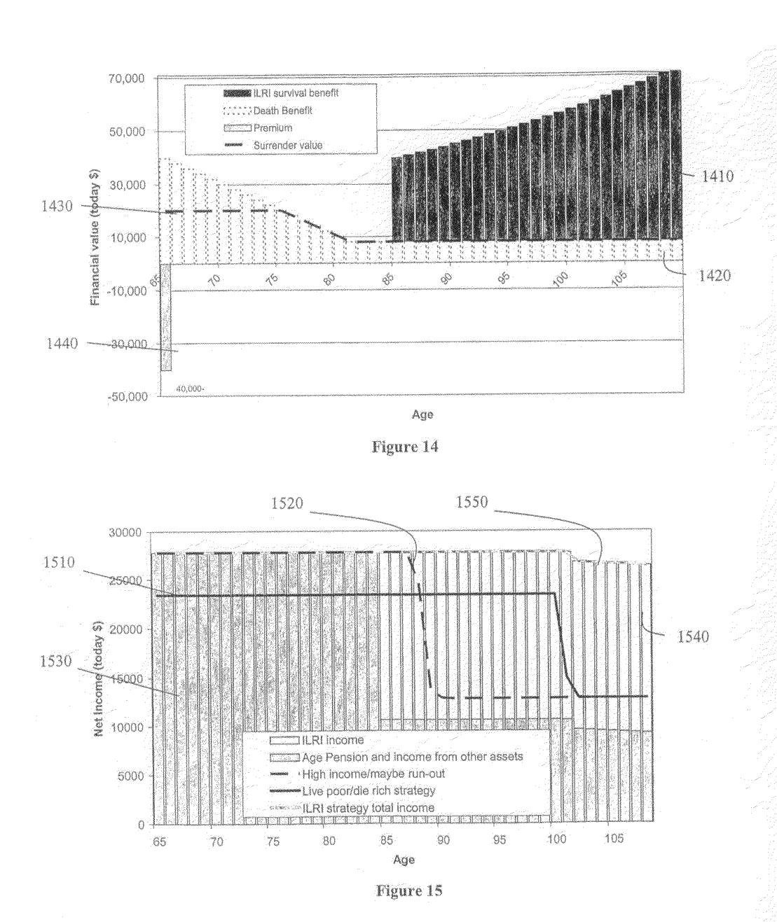

As shown in FIG. 14, an illustration of a typical benefit structure, the product accepts a premium 1440, pays out a “Survival Benefit” 1410 each year beyond a certain age, provides for a “Death Benefit” 1420 and has a “Cash surrender value” 1430.

Investors have legal entitlements to the product's benefits. However, the product may be administered by reference to a unitised investment pool. Each surviving member is associated with a “notional” share of the pool, also termed the “notional account balance”. When an investor dies, the proportion of the deceased investor's notional account balance required to satisfy their Death Benefit is returned to the estate of the deceased investor. The remainder is distributed amongst surviving members of the pool. Since investors will die at different points in time, the Notional Account Balances of those who survive longer are cross-subsidised by those who die earlier. Survival Benefits are also paid by redeeming an appropriate share of the notional account of an investor each year the investor survives beyond the survival age. It is important to note that the Notional Account Balance is a useful administration tool and allows the product to be integrated more easily with existing account-based retirement income products—however it in no way need confer legal ownership to the investor.

The ILRI structure is configured to pay out its capital through survival benefits, death benefits and surrender values to investors. Aside from these benefits, transparent asset-based fees need be the only cash-flows drawn. In this way, if investors in the ILRI structure on average live longer (i.e. the group or systematic longevity risk), each survivor gets paid proportionately lesser amounts. Assets thus match liabilities. Because the individual longevity risk is isolated from the group longevity risk, the ILRI product may be offered cost-effectively in comparison with traditional annuity structures or guaranteed lifetime income product structures. This may therefore give rise to a transparent, flexible, investor directed, pooled insurance vehicle

As illustrated in FIG. 15, when the ILRI product is purchased as one asset in a retirement income portfolio, the total income 1550 a retiree is able to draw will either (a) be 17% higher than a conservative draw-down strategy 1510 designed to preserve the retiree's capital until age 100, or (b) or provide the same income as a more aggressive strategy 1520 but eliminate the significant risk of the retiree outliving their savings. The strategy is a combination of income drawn from normal products and the age pension 1510 and the income drawn from the ILRI product 1520. This proposition solves the “Live Poor or Run-out” conundrum described above and is expected to have significant appeal for the coming generation of retirees. This provides a retirement income strategy method for combining ILRI assets with traditional account-based retirement income products to increase the average total retirement income a retiree can draw and eliminate the risk of funds running out.

Many implementations of the ILRI arrangement described herein are possible. One implementation is a “Stand-alone ILRI” product. This product is issued to the investor isolated from other financial products. Another implementation is an ILRI Asset Class (“ILRAC”) product. This product is designed to provide the ILRI functionality as a “unitised” investment option within an umbrella retirement income product, for example an Allocated Pension. The following text first describes the operation of the Stand-alone ILRI and then describes methods and systems for the ILRAC.

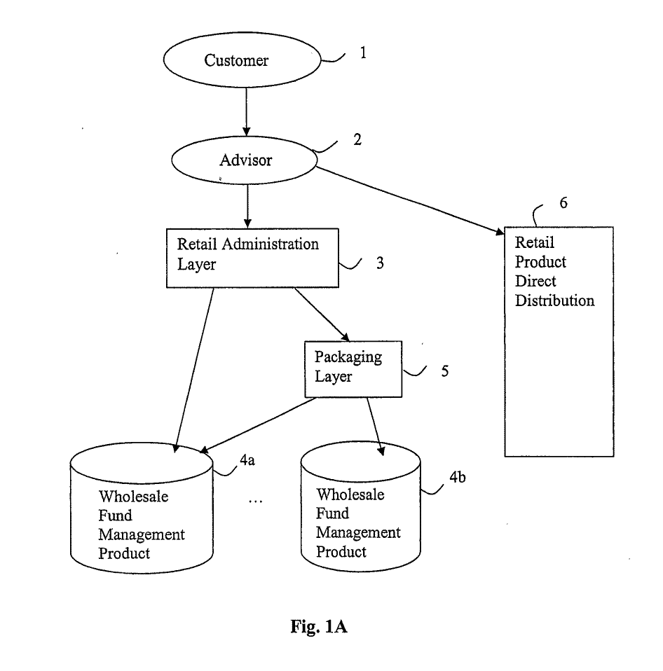

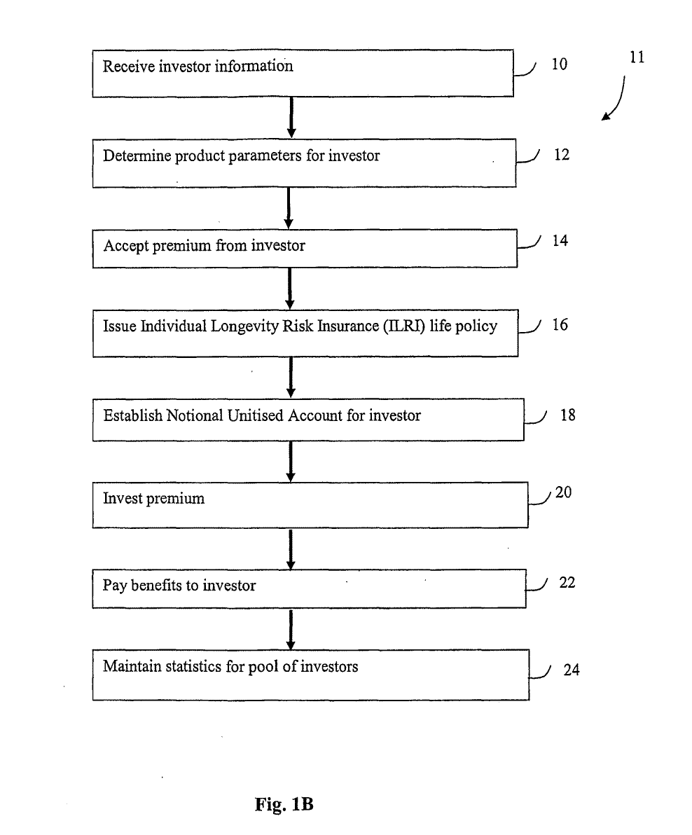

FIG. 1B provides an overview of a method 11 in which the ILRI product is provided to an investor. The method 11 is applicable to both the stand-alone ILRI product and the ILRAC product. In the case of the ILRAC product, the product is received through an Allocated Pension system.

In step 10, personal information about the investor is received, including information relating to the investor's mortality risk factors at the time of making the investment. These factors include the age of the investor at the time of investment and the sex of the investor. The investor's name, address and contact details are also gathered.

In step 12 the investor, possibly in collaboration with an advisor, determines parameters of the ILRI product that match needs and choices of the investor. The investor may choose between different product benefits and options, for example whether the investment is single-life or reversionary (e.g. where the product is taken out by a couple, for example either married or in a de-facto relationship). The investor may also choose between different investment options that reflect the risk profile of the investor, and hence the value at risk of the investment. The ILRI product is configurable to isolate different investment pools such that investors may receive returns that reflect the investors' underlying investment strategy. This affords a method to provide pooling of benefits, options to choose investment strategy, options to change investment strategy and investment returns to the investor reflecting only the performance of their investment options. As described in more detail below, an advisor may assist in clarifying the investor's retirement income goals and requirements.

A further parameter to be determined is the age at which benefits will start issuing to the investor (referred to herein as the “survival age”). In one arrangement the survival age is the actuarial life expectancy of the investor at the time of making the investment. Alternatively, a fixed age, such as eighty-five years, may be specified. The option of bringing forward the start date of the benefits may also be offered. However, such an early draw-down of benefits is priced to avoid selection effects impacting on other investors (e.g. the actions of investors who have a higher probability of dying sooner rather than later).

An illustration tool has been developed to help the adviser 2 and investor 1 optimise the ‘holistic income strategy’ and better manage the difficult choice between income early in retirement and providing for financial needs in later life. The tool accepts information about the investor's entire financial status and retirement income goals. The tool helps the adviser 2 and the investor 1 optimally select all the product parameters described above. The illustration tool is described in more detail below.

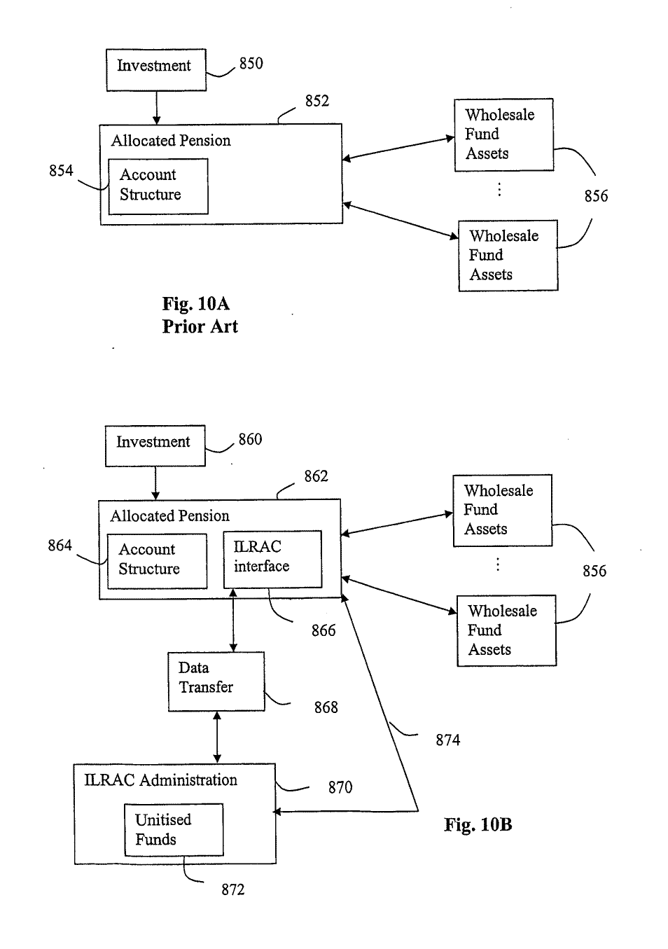

In step 14 the ILRI provider accepts a premium from the investor. In one arrangement the premium is a single payment, for example 15% of the investor's savings. In an alternative arrangement an ILRI contract is offered as a ‘rider’ on a standard allocated pension or as periodic premium payments. In the rider arrangement, annual premiums may be automatically deducted from the allocated pension to fund the ILRI product. The ILRI provider and the allocated pension provider may be one and the same. If the product is an ILRAC, the investor invests his or her investment 860 into the allocated pension 862. The investor (who may be assisted by an advisor or staff of the issuing company of the allocated pension 862) allocates an amount (typically about 85%) into standard allocated pension investment options 856. The remaining amount from the investment 860 is allocated to one or more ILRAC fund options 870, as described below in more detail with reference to FIG. 10B

In step 16 the ILRI product provider issues an ILRI life policy in favour of the investor. Alternatively, in the case where the ILRI is written as a group life policy, the new investor's life is added to that group policy. In step 18 a notional unitised account is established for the investor.

The premium is invested in unitised underlying investment accounts (step 20). The value of each unit varies with the market performance net of fund management fees extracted from the market performance. Other fees such as commissions and administration charges may be charged to each notional unitised account and settled by selling an appropriate number of units. This allows investors with different risk profiles to invest in a pooled risk product at the same purchase unit price but to manage the pool such that they achieve returns equitable to their risk classification and are shown equitable return expectation projections at the point of sale.

The notional unitised account structure allows individual investors to choose and change the underlying investment strategy for their funds. The account structure also accommodates different fee rates for different investors.

In step 20 the investor's assets are invested into underlying investments, often managed funds. The investor may be provided with a menu of options that allow the investor to select an investment strategy. Alternatively, investment management packages may be selected and managed on behalf of the investors. Investors may reallocate assets between ILRI options over time. This may be done by selling units at the unit price and using the proceeds to buy units in another selected ILRI option at the unit price.

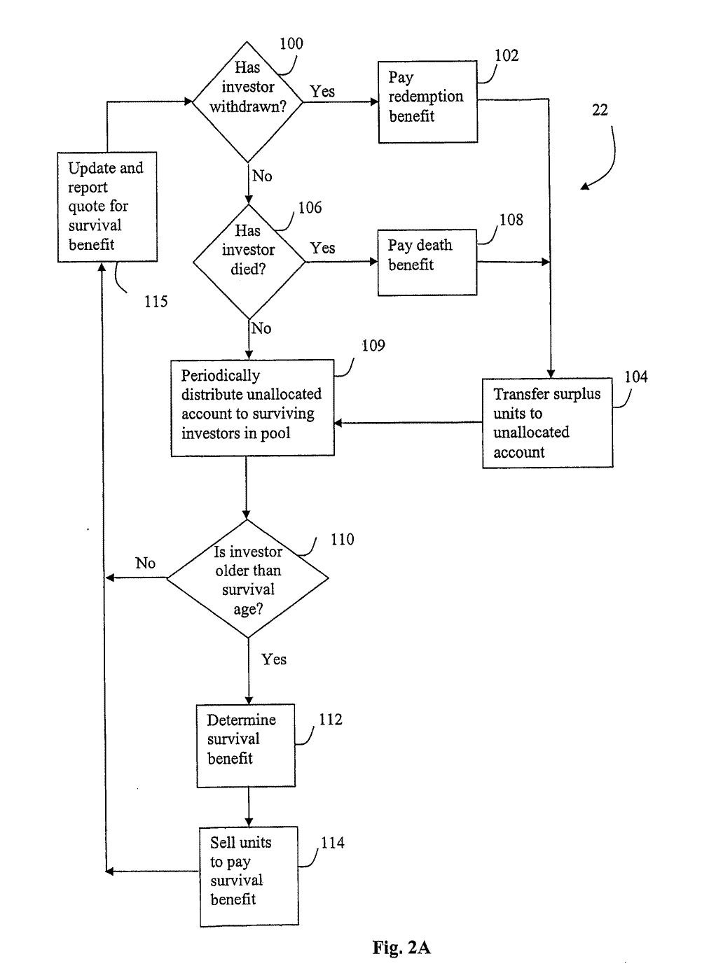

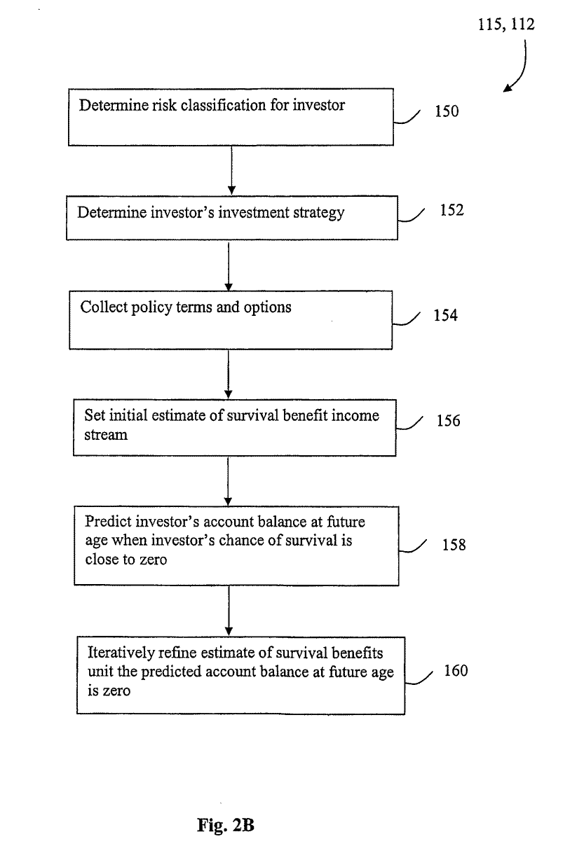

In step 22, benefits are paid to the investor. This process is described in more detail with reference to FIG. 2A. The benefits include redemption benefits, death benefits and, if the investor lives long enough, survival benefits. As described below, surplus units from investors who have died or withdrawn are notionally allocated to the notional account balances of surviving members. Such allocations are termed “Longevity Bonuses”.

The ILRI provider maintains detailed statistics for the pool of investors. This is illustrated as step 24 in FIG. 1B, but is in practice a regular and on-going task. The determination of survival benefits is dependent on an actuarial mortality table that reflects different mortality rates for agreed risk categories (for example age and sex). Initially, the actuarial mortality table may be set by an actuary dependent on appropriate actuarial and regulatory standards. However part of the maintenance performed in step 24 is a feedback process of updating and improving the actuarial mortality table based on the actual mortality figures in the pool of investors. In the case of the ILRAC, implementing this step 24 may involve data transfer 868 between the allocated pension administration 862 and the ILRAC 870, as shown in FIG. 10B.

### Operating Environment

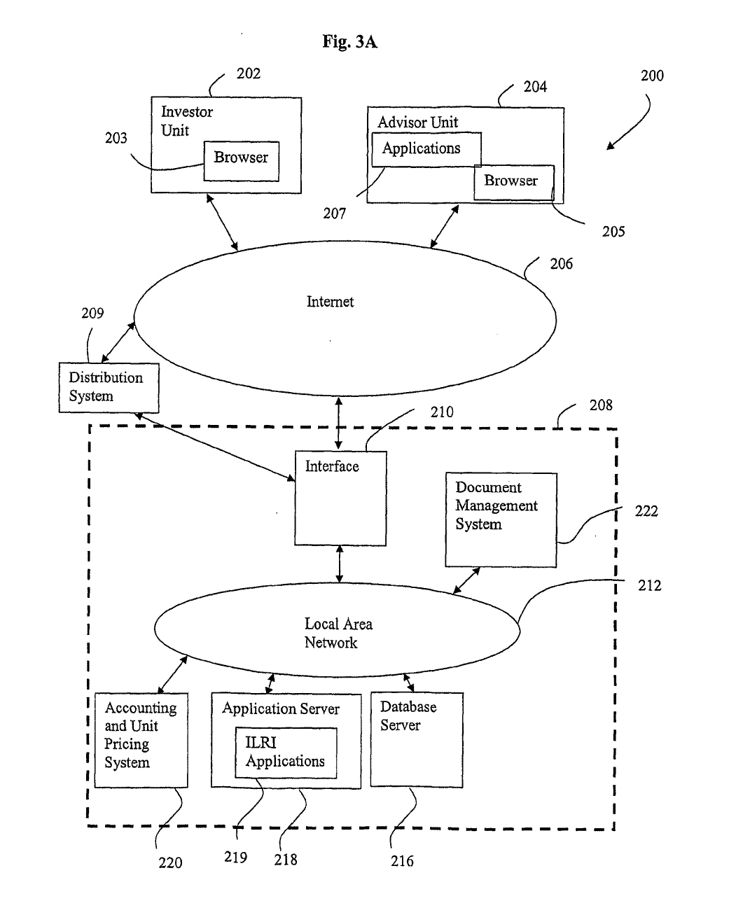

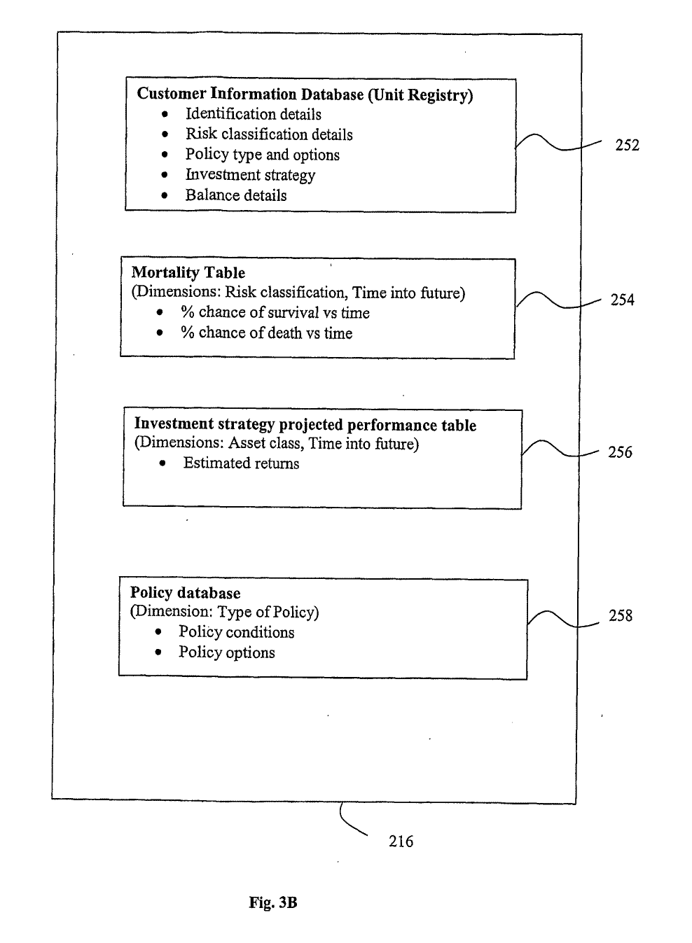

FIG. 3A illustrates an operating environment 200 in which the described ILRI product may be implemented. An integrated technology platform 208 of the ILRI provider is linked to the Internet 206. Individual investors may access the MRI provider electronically from an investor unit 202 which may, for example be a personal computer used by the investor. The investor may communicate via email with the ILRI provider, or may use browser software 203 running on the investor unit 202 to access one or more web pages hosted by the ILRI provider. Such web pages may, for example, provide the investor with information concerning his or her notional unitized account balance and the current performance of the different underlying investments.

One or more financial advisors may also communicate with the ILRI technology platform 208 from an advisor unit 204 which may, for example, be a computer used by the advisor. In some cases investors may prefer to communicate with the ILRI provider via an advisor rather than directly over the Internet 206. The advisor unit 204 typically includes browser software 205 for viewing information over the Internet 206 and one or more software application packages 207 for product presentation and financial strategy modelling.

Advisers and/or investors may access the ILRI technology platform 208 through a third party distribution system (eg. a Platform) 209.

For convenience, a single investor unit 202, advisor unit 204 and distribution system 209 are shown. Practically, there may be many such units 202, 204, 209.

“Manual” interfaces with the ILRI provider may also be used instead of, or supplementing, communication over the Internet 206. In such “manual” interfacing, printed documents, explanatory brochures and tools, faxes and telephone calls are used. Information received by the ILRI provider is added to databases on the ILRI technology platform 208.

The ILRI technology platform 208 has one or more interfaces 210 supervising communication with the Internet 206 and/or secure connections with the distribution system 209. The interfaces 210 may provide services such as client registration and firewalls for security.

The components of the ILRI technology platform 208 may communicate via a local area network (LAN) 212. The components connected to the LAN 212 include one or more application servers 218 that execute ILRI applications 219 related to the maintenance of the ILRI product. Such application servers 218 may comprise a general-purpose computer or other device selectively activated or reconfigured by a computer program. The ILRI applications 219 perform tasks such as the calculation of survival benefits and the redistribution of unallocated account units. In addition, the one or more application servers 218 may host web pages to provide product information to investors and advisors.

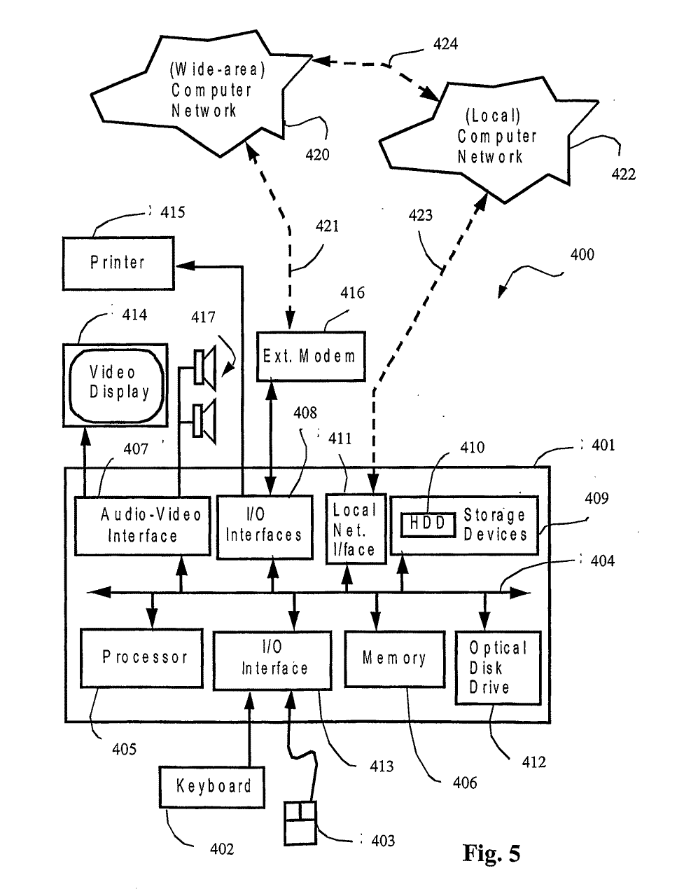

The algorithms and displays presented herein are not inherently related to any particular computer or other apparatus. The structure of a conventional general purpose computer which may, for example, be used as units 202, 204 or application server 218 is described below with reference to FIG. 5.

One or more database servers 216 connect to the local area network 212. As shown in FIG. 3B, the databases stored on the one or more database servers 216 include a customer information database (or unit registry) 252 that stores identification details for the investors and an indication of whether an investor is still alive. The unit registry also stores risk classification details for the investors (e.g. an investor is a 65 year old female with a single life policy) and the policy type and options for each investor (e.g. the investor has specified a standard death benefit, CPI-linked income, a negotiated fee structure and an expected income start date). The unit registry 252 also stores details of the investment strategy chosen by the investor (e.g. an asset class allocation that may vary with time). The unit registry 252 also stores the investors' balance details including the unit account balance and an investor's time in the fund.

Actuarial mortality tables 254 are also stored in the one or more database servers 216 and are updated to reflect the actual mortality history of investors in the ILRI product. The mortality tables 254 store information about investors' chances of survival versus time and chances of death versus time for defined risk classifications.

Another database stored in the one or more database servers 216 is a table 256 of projected performance of different investment strategies. The table provides an estimate of future returns for different asset classes. These estimates are used in quoting expected benefits and in calculating survival benefits. The predictions in table 256 may be updated based on the actual returns achieved by the asset classes.

The one or more database servers 216 also store a policy database 258 that provides information about each of the types of policy available. For each policy type, the database 258 contains information about policy conditions (for example the death benefit structure, annuity structure, fee structure and underwriting approach). The database 258 also contains information about different options available for each policy type (e.g. single/joint life, any options regarding income start dates, and fee ranges).

An Accounting and Unit Pricing system 220 linked to the local area network 212 maintains a corporate general ledger and accounts, including the notional unitized accounts of the ILRI product and performs regular unit pricing calculations.

The ILRI technology platform 208 also includes a document management system 222 that may be used, for example, to print reports and account statements and manage mailing to investors and advisors.

In the system shown in FIG. 3A, the investor interacts with the ILRI provider directly or via an advisor. In alternative arrangements there may be a distribution channel (for example a financial institution) interposed between the ILRI provider and the investor or the advisor. In such arrangements the investor (or advisor) may interact with the distribution system or platform 209 which, in turn, interacts with the technology platform 208 of the ILRI provider.

Alternatively, the advisor may be employed by, or associated with, the distribution channel.

The ILRI provider may maintain multiple pools of investors which are isolated from one another for the purposes of bonus unit redistribution. A single investor may choose to allocate their ILRI assets among several investment pools. Separate pools may also be maintained for each distribution channel. In this arrangement, the unit re-allocation between the customers of a particular distribution channel is “zero-sum” and no transfers are required at a distribution channel wholesale accounting level.

Separate pools may be maintained for different investment options. In this arrangement the longevity bonuses distributed to an investor do not depend on the investment performance of investment options not selected by the investor. Arrangements may also be made where lives are pooled across multiple investment pools such that the ‘bleeding’ of investment performance between participants in different pools is minimised. In this scenario, however, it is impossible to ensure that the investor achieves returns which depend only on the performance of their investments and the longevity performance.

Thus, the unit registry 252 may maintain information about multiple investment pools, where investors may be members of more than one pool.

In a typical implementation, each pool is unitised and unit-priced similar to many standard funds management products.

### Description of General-Purpose Computer

The method of providing and maintaining the ILRI product may be implemented using a computer system 400, such as that shown in FIG. 5. Method steps may be effected by instructions in the software that are carried out within the computer system 400 which may be used, for example, as the investor unit 202, the advisor unit 204 or the application servers 218. The instructions may be formed as one or more code modules, each for performing one or more particular tasks. The software may be stored in a computer readable medium, including the storage devices described below, for example. The software is loaded into the computer system 400 from the computer readable medium, and then executed by the computer system 400. A computer readable medium having such software or computer program recorded on it is a computer program product.

As seen in FIG. 5, the computer system 400 is formed by a computer module 401, input devices such as a keyboard 402 and a mouse pointer device 403, and output devices including a printer 415, a display device 414 and loudspeakers 417. An external Modulator-Demodulator (Modem) transceiver device 416 may be used by the computer module 401 for communicating to and from a communications network 420 via a connection 421. The network 420 may be a wide-area network (WAN), such as the Internet 206 or a private WAN such as network 212. Where the connection 421 is a telephone line, the modem 416 may be a traditional “dial-up” modem. Alternatively, where the connection 421 is a high capacity (eg: cable) connection, the modem 416 may be a broadband modem. A wireless modem may also be used for wireless connection to the network 420.

The computer module 401 typically includes at least one processor unit 405, and a memory unit 406 for example formed from semiconductor random access memory (RAM) and read only memory (ROM). The module 401 also includes an number of input/output (I/O) interfaces including an audio-video interface 407 that couples to the video display 414 and loudspeakers 417, an I/O interface 413 for the keyboard 402 and mouse 403 and optionally a joystick (not illustrated), and an interface 408 for the external modem 416 and printer 415. In some implementations, the modem 416 may be incorporated within the computer module 401, for example within the interface 408. The computer module 401 also has a local network interface 411 which, via a connection 423, permits coupling of the computer system 400 to a local computer network 422, known as a Local Area Network (LAN). As also illustrated, the local network 422 may also couple to the wide network 420 via a connection 424, which would typically include a so-called “firewall” device or similar functionality. The interface 411 may be formed by an Ethernet™ circuit card, a wireless Bluetooth™ or an IEEE 802.21 wireless arrangement.

The interfaces 408 and 413 may afford both serial and parallel connectivity, the former typically being implemented according to the Universal Serial Bus (USB) standards and having corresponding USB connectors (not illustrated). Storage devices 409 are provided and typically include a hard disk drive (HDD) 410. Other devices such as a floppy disk drive and a magnetic tape drive (not illustrated) may also be used. An optical disk drive 412 is typically provided to act as a non-volatile source of data. Portable memory devices, such optical disks (eg: CD-ROM, DVD), USB-RAM, and floppy disks for example may then be used as appropriate sources of data to the system 400.

The components 405, to 413 of the computer module 401 typically communicate via an interconnected bus 404 and in a manner which results in a conventional mode of operation of the computer system 400 known to those in the relevant art. Examples of computers on which the described arrangements can be practised include IBM-PC's and compatibles, Sun Sparcstations, Apple Mac™ or alike computer systems evolved therefrom.

Typically, the application programs discussed above are resident on the hard disk drive 410 and read and controlled in execution by the processor 405. Intermediate storage of such programs and any data fetched from the networks 420 and 422 may be accomplished using the semiconductor memory 406, possibly in concert with the hard disk drive 410. In some instances, the application programs may be supplied to the user encoded on one or more CD-ROM and read via the corresponding drive 412, or alternatively may be read by the user from the networks 420 or 422. Still further, the software can also be loaded into the computer system 400 from other computer readable media. Computer readable media refers to any storage medium that participates in providing instructions and/or data to the computer system 400 for execution and/or processing. Examples of such media include floppy disks, magnetic tape, CD-ROM, a hard disk drive, a ROM or integrated circuit, a magneto-optical disk, or a computer readable card such as a PCMCIA card and the like, whether or not such devices are internal or external of the computer module 401. Examples of computer readable transmission media that may also participate in the provision of instructions and/or data include radio or infra-red transmission channels as well as a network connection to another computer or networked device, and the Internet or Intranets including e-mail transmissions and information recorded on Websites and the like.

### Payment of Benefits

FIG. 2A illustrates in more detail how benefits are paid to the investor in step 22. The methods of FIG. 2A may, for example, be performed by the ILRI software applications running on the one or more application servers 218. The ILRI software applications retrieve data from the database servers 216 and return processed information to the databases. The method steps 22 may be performed separately for each of the multiple pools maintained by the ILRI provider.

Although FIG. 2 illustrates a particular sequence of steps, the order of individual steps may be varied or performed in parallel.

Step 100 checks whether the investor has withdrawn voluntarily from the ILRI pool. If so (the Yes option of step 100), a cash surrender value 1430 is paid to the investor in step 102. The cash surrender value may be determined in the same way as the death benefit discussed below or may be different as illustrated in FIG. 14. The benefit is settled by selling a proportion of the units in the investor's notional unitised account balance. After a member draws the surrender value it is possible to continue to administer their remaining notional account. In this way, if the member achieves the survival age, a survival benefit 1410 can still be paid, albeit at a reduced level. This option may attract a penalty.

The redemption benefit is typically less than the notional account balance of the investor, and in step 104 surplus units are transferred to an ‘unallocated’ account. Periodically, in step 109, the unallocated account units are distributed as ‘Longevity Bonus Units’ (LBU) to surviving investors in the pool in which the unallocated units are held.

Step 106 checks whether the investor has died. If so, a death benefit is paid in step 108. The algorithm checks if the policy has a surviving reversionary life (Step 108). If so, the account balance can be adjusted down to a level appropriate to deliver the reversionary income the couple selected at policy initiation (for example 70% of the originally planned joint income) to the remaining single life. The calculation is performed by applying slightly different constraints on the typical pricing algorithm described in detail herein. Surplus units are transferred to the unallocated account (Step 104). The product operates from then on as if for a single-life individual.

In one embodiment, before the investor reaches the survival age, the provider relies on the investor's estate to notify the provider of the investor's death. Once the survival age is reached and benefits are due, the survival of the investor may be verified before payment. The death benefit is typically less than the notional unitised account balance of the investor, and may be set to a predetermined proportion of the notional account balance. In one arrangement the proportion varies dependent on the investor's age at death.

In an alternative arrangement, the death benefit is calculated as a proportion of the initial premium paid by the deceased investor. Again, this proportion may be varied with the investor's age at death. For example, the proportion may reduce linearly from 95% of the nominal premium to 20% of the nominal premium over the fifteen years between ages 65 to 80. Thereafter, the proportion may stay constant at 20% of the nominal premium, regardless of the age at which the investor dies. The ‘nominal premium’ is the amount originally invested, not adjusted for inflation. Paying the death benefit as a proportion of the initial premium may be attractive from a marketing perspective, as potential investors have a predictable benefit. However, this option increases the volatility in the survival benefits paid by ILRI product.

Step 109 is performed periodically, for example quarterly, and reallocates the unallocated account to surviving investors in the pool under consideration. Step 109 is described in more detail below.

Step 110, which is performed at regular intervals (for example quarterly), checks whether the investors are older than the established survival age. If an investor is not yet old enough, no benefit is paid in the following payment period (unless the investor dies or withdraws voluntarily). If, however, the investor is older than his or her survival age, then in step 112 a survival benefit is calculated to be paid to the investor in the following payment period. The survival benefit is determined by reference to the notional unitised account balance of the investor and a proportion of the total notional account units payable upon each survival date. The survival benefit for a payment period may be paid in a lump sum or broken into periodic (e.g. monthly) payments.

In step 114 an appropriate number of units is sold in order to fund payment of the survival benefit. In step 115 a report is issued to the investor with information about the survival benefit and the current and predicted performance of the ILRI pool. The logical flow then returns to step 100 to monitor whether the investor withdraws from the pool or dies in the next period.

Step 115 is also performed when the investor is still younger than his or her survival age (i.e. the NO option of step 110). Where no survival benefit is yet due, step 115 updates the relevant figures, provides a report to the investor detailing the current performance of the pool, and indicating the expected future benefits to the investor.

### Clearing the Unallocated Account (Step 109)

In step 109, unallocated account units are periodically distributed as LBUs to surviving investors in the pool in which the unallocated units are held. The LBU distribution may be performed by an ILRI software application 219 running on application server 218. The bonus unit redistribution may be performed separately for different investment pools. An ILRI calculation engine (which may be one of the ILRI applications 219) communicates with the database servers 216 to extract the required information concerning the pool. The calculation engine then determines the appropriate reallocation and feeds a reallocation instruction file back to the unit registry 252 to update the unit balance of investors in the pool.

The percentage of units allocated to each investor may be determined by way of distribution statistic, R, which represents the funds risk taken by each investor during the period P since the last clearing of the unallocated units. In one arrangement R is determined proportional to:
The percentage of the period P the investor was in the fund; multiplied by
The average number of fund units the investor held during the period P, less the number of units that would have been required to pay out the investor's death benefit had the investor died during the period P; multiplied by
The percentage chance the investor had of dying during the period.

The proportion of unallocated units distributed to investor i, is then:

$$Proportion = \frac{{R}_{i}}{{\sum }_{all j} {R}_{j}} \qquad ( Equation 1 )$$

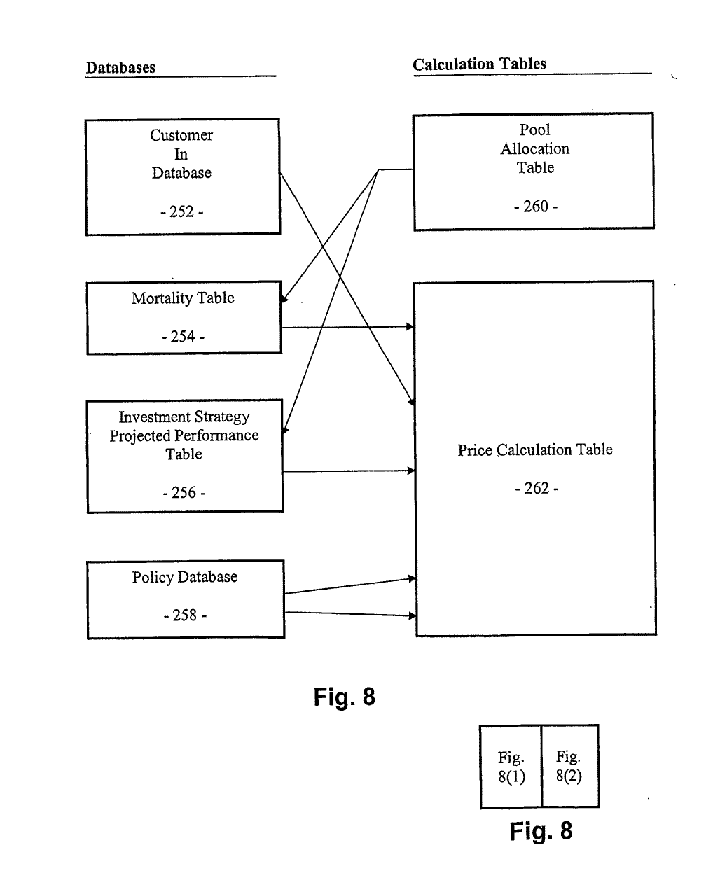

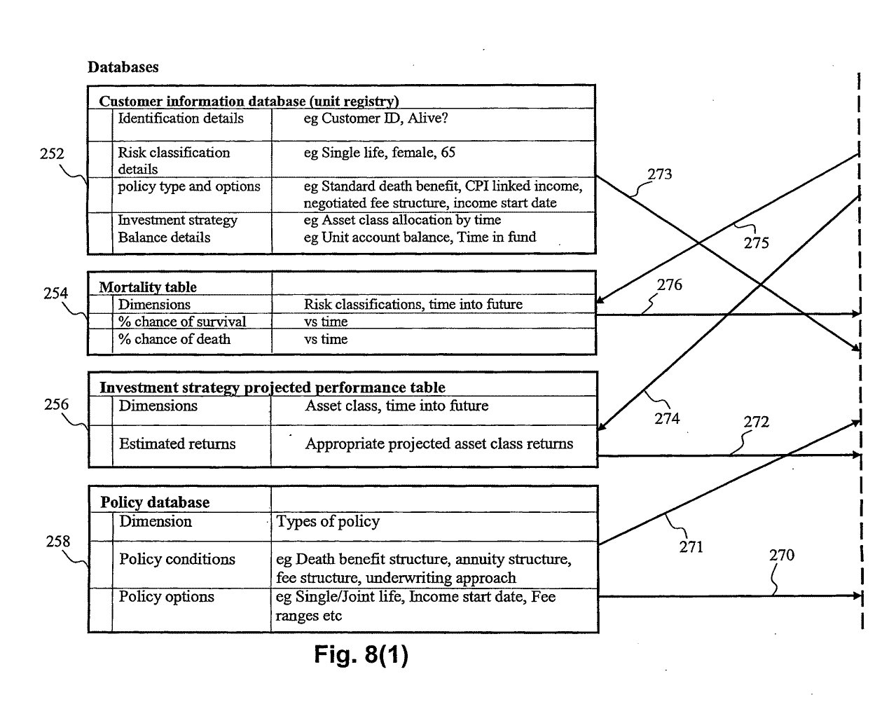

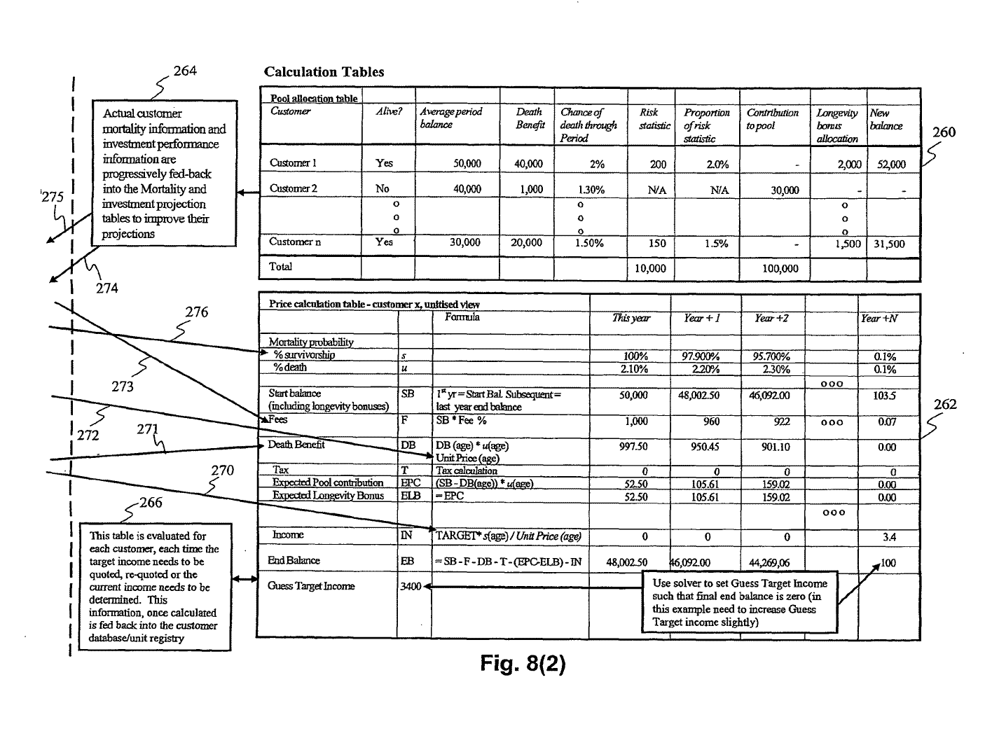

This proportional calculation and unallocated account redistribution is illustrated in FIG. 8 table 260. Note that in the case of the ILRAC, the redistribution transactions may be determined in the ILRAC administration system 870 and communicated via data transfer 868 to the Allocated Pension system 862 so that the reallocation can be executed.

### Projecting Survival Benefits and Determining Survival Benefits Currently Due

At various times during an investor's interaction with the ILRI provider it is necessary to project future survival benefits or to determine survival benefits that are currently due. Early in the sales process (steps 10, 12) the customer is provided with a quote of expected future benefits. See also the discussion of method 300 below, where multiple income profiles are calculated for display to the potential investor.

Once the investor has entered an ILRI pool, the quote of future survival benefits is updated in each payment and reporting period (step 115). If the investor reaches the survival age, then in each payment period an appropriate current benefit for surviving investors is determined in step 112. The following section describes a method for quoting the benefit, updating the quote and calculating the current benefit. The method may be implemented on ILRI application software 219 running on one or more application servers 218.

A method for quoting, re-quoting and determining survival benefits is shown in FIG. 2B and may be used, for example in steps 112, 115 and 308. The illustrated method uses a numerical optimisation rather than a closed-form solution. The method allows investors with different risk profiles (e.g. age, gender and other underwriting characteristics), different fee structures, different policy terms and different policy purchase dates to receive a substantially equitable distribution of survival benefits. As each new investor is added to a pool, the new investor's policy is priced such that there is no probability-weighted expected financial impact on other investors in the pool. This is also true of other actions taken by any particular investor in a pool, such as renegotiating the fee structure. In this way, the numerical solution is a generalisation of closed form solutions which may exist in certain constrained or simplified cases.

In step 150 a risk classification is determined for the investor. Initially this is done after capturing information from the investor (e,g, step 302). Thereafter, the risk classification information may be retrieved from the customer information database 252. In one implementation the only underwriting categories that affect the risk classification are the investor's age and gender and whether the investor's policy has a single or joint life status. The method can be generalised to any appropriate risk classification (eg under-written health to provide impaired life pricing) As such the product may be offered with any conceivable level of underwriting—from no underwriting, to detailed health check underwriting, which may become important in competitive markets.

In step 152 the investor's investment strategy is determined. Initially this is determined in consultation with the investor. Thereafter, the investment strategy may be retrieved from the customer information database 252, although the ILRI provider may offer the option of changing an investment strategy as desired. Once the investment strategy is known, a corresponding best estimate of returns is available from the investment strategy projected performance table 256. Such best estimates are based on the historical market performance of the assets underlying the investment strategy and may be informed by an asset consulting expert.

In step 154 the policy type chosen by the investor is established, initially by consulting with the investor and thereafter by retrieving information from the customer information database 252. Details of the policy terms are collected from the policy database 258, for example what death benefit structure is used in the policy and whether the policy offers a CPI-linked or flat income stream structure. The policy options selected by the investor are also determined. As such the investor may be offered a broad array of benefit structure choices. These may be equitably priced into policy options by projecting different benefit levels

In step 156 an initial estimate or guess of the investor's survival benefit income stream is established. Using this initial estimate, the future unit transactions for the investor are predicted in step 158, weighted by mortality probability. The cash-flow predictions are projected up to a future date (or terminal age) when the investor has a zero (or appropriately close to zero) probability of still being alive. For example, the unit transactions may be projected up to an age of 120 years. Step 158 outputs a predicted account balance for the investor at the terminal age. Note that actuarial discretion may be required to model the low-probability (very long life) end of the mortality table since current tables do not generally extend to 120.

Then, in step 160 the estimate of the survival benefit is iteratively refined until the cash flow modelling predicts that the investor's account is run down to zero at the specified terminal age. The iterative optimisation may be performed using standard numerical optimisation techniques.

Since the product pools a finite number of members, there is a stochastic uncertainty in the how the pool's mortality is expected to evolve. In order to smooth survival benefit payments to customers, even when numbers in the pool reduce, the optimisation in step 160 can be set up to calculate an survival benefit that can (at least) be supported by the pool to some specified probability level (say 95%). In practice, this technique sets aside a reserve that can be used to smooth the evolution of survival benefits over time. This reserve will reduce the survival benefits payable in the short term—as the number of members in the product increases the law of large numbers reduces the reserve per member—allowing a larger survival benefit to be “safely paid”. The solved value of the survival benefit may then be provided to the investor as a quote (e.g. in step 115 or step 308). Note that, assuming the fee structure of the ILRI product does not change with the level of funds under management, the quote is constant as a ratio of the initial amount invested. This may have a simplifying effect on strategy modelling for the investor's financial planning (see steps 304, 306 below). The strategy modelling software may take an ‘income ratio’ from the quoting method (steps 150-160) as a modelling input.

The method of steps 150-160 may be used on an on-going basis (e.g. in step 115) to re-quote the projected survival benefit using updated figures. During the income phase of the ILRI product, the method of steps 150-160 is used in step 112 to determine the actual number of units that should be sold to provide the investor with his or her benefit payment.

FIG. 8 shows an illustrative example in which the method of FIG. 2B is implemented using Microsoft Excel (Trademark of Microsoft Corporation) spreadsheets. Information is drawn from databases 252, 254, 256, 258 as described above. A pool allocation table 260 contains information about a pool of n investors (or customers), including a customer ID, whether the investor is still alive, the investor's average balance during a current period; the investor's death benefit and chance of death during the period; each investor's risk statistic in the period (used to calculate bonus distributions); each investor's proportion of the risk statistic, the investor's contribution to the pool (e.g. customer 2 has died and contributed 30,000 units to the pool), the longevity bonus allocation to the investors, and the investors' new unit balance. As shown in step 264, the actual investor mortality information and investment performance are fed back into the mortality table 254 and investment projection table 256.

A price calculation table 262 is used to determine a survival benefit for each investor. In step 266, the table 262 is evaluated for each customer each time the target income needs to be quoted or re-quoted, or when the current survival benefit needs to be determined. The information calculated using table 262 is fed back into the customer information database 252.

Table 262 determines unit transactions from a current year to a projected terminal year (Year+N) in which customer x's % survival chance has fallen to some low value, for example 0.1%. The investors start balance (SB) for each year is determined, and the expected fees (F) payable in each year are determined. The projected death benefit (DB) for each year is calculated, together with a tax calculation for each year. An expected pool contribution (EPC) is calculated for each year, together with the expected longevity bonus (ELB). The Income (IN) is calculated and a predicted End Balance (EB) for each year. In the example an initial income target of 3400 is guessed, which yields an end balance in (YEAR+N) of 100 units. In step 268 the spreadsheet solver is used to adjust the target income until the final end balance is zero.

Note that the constraints and objectives of the optimisation process may be rearranged. For instance, it is possible to hold a target income as a constraint and calculate the required variation of investment strategy, death benefit structure or annual premium level required to achieve the constrained income. Such an approach may be attractive for some clients.

While the iterative optimisation described above provides considerable flexibility in determining benefits, closed-form calculations are also possible under certain situations.

### ILRAC Product

The ILRI product benefits may also be delivered by way of an investment option provided within existing retirement income products such as the Allocated Pension. This implementation of the product has several commercial advantages. It is easy for an adviser to sell as the ILRAC product can be described as a simple asset-allocation strategy. The ILRAC product is cooperative rather than competitive with the providers of Allocated Pensions, which control distribution access and a large proportion of the existing invested market. The ILRAC business model also has significant cost advantages, for instance it may minimise and/or avoid expensive additional reporting mail-outs to customers by integrating its reporting into the allocated pension's reporting.

The existing allocated pension structure is illustrated in FIG. 10A. An investor provides an investment 850 to an allocated pension 852 that has an account structure 854 that enables the investor to monitor the performance of his or her investment. The company issuing the allocated pension 852 is generally an account administrator and gateway to access wholesale funds 856.

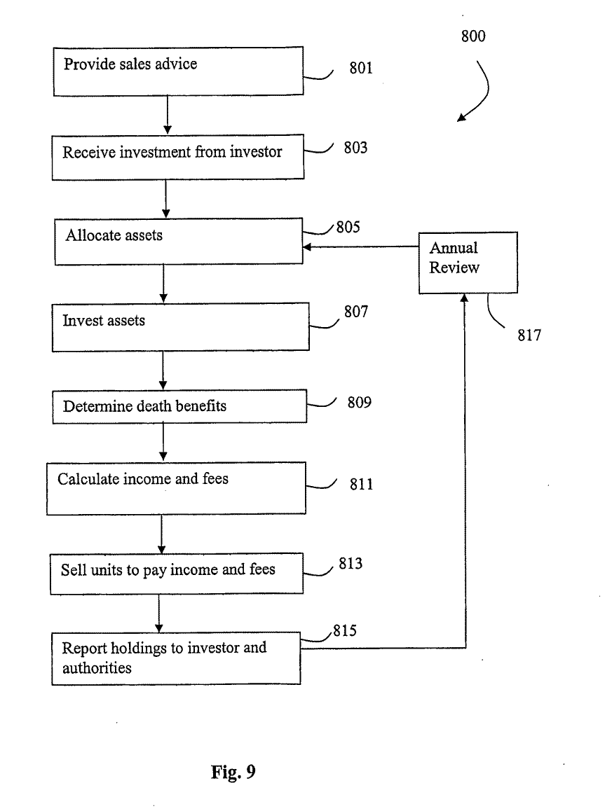

The use of the allocated pension structure is illustrated in the method 800 of FIG. 9. In step 801 the adviser 2 illustrates the allocated pension to the investor 1 and sells the product. The investor's investment 850 is transferred into the account structure 854, typically a Master Trust, in step 803. The adviser 2 allocates the investment to different underlying wholesale fund assets 856 in step 805. The Fund Managers controlling the wholesale assets 856 invest the assets and achieve a return (be it negative or positive) in step 807. In step 809 the death benefits payable in the event of the investor's death are determined. Periodically (often quarterly) in step 811 the allocated pension provider values the investor's account for the purposes of income determination (V) and fee payment. The investor 1, often with the help of the adviser 2, is then able to select an income to drawdown between two values (Iₘᵢₙ and Iₘₐₓ) determined by reference to valuation factors (PVF's):

Iₘᵢₙ=V/PVFₘᵢₙ AND Iₘₐₓ=V/PVFₘₐₓ (Equation 2)

The PVF factors are set legislatively and vary with the investor's age. In step 813 units in underlying investments 856 are sold to pay the selected income to the retiree and fees. In step 815 the account balance and investment performance are reported to the investor and relevant authorities. In step 817 the adviser and the investor meet (typically annually) to review the performance of the investments and the account. Process flow then returns to step 805, in which assets may be re-allocated.

FIG. 10B illustrates the structure of an allocated pension 862 that offers the option of investment in an ILRAC product. An investor provides an investment 860 to the allocated pension 862 that has an account structure 864 that enables the investor to monitor the performance of his or her investment. The company issuing the allocated pension 862 is generally an account administrator and gateway to access conventional wholesale funds 856. In addition, the allocated pension 862 offers investment in one or more ILRI Asset Classes (ILRACs).

While the illustration above is specific to integrating the product with an Australian Allocated Pension, many other countries have investment administration and/or flexible retirement income tax structures with similar features. Accordingly, variations of the described implementation are possible, and indeed most likely, with changes in jurisdiction and government regulation of pension schemes.

When the ILRAC is added to the allocated pension 862, the ILRAC operates such that the ILRI product investment is provided to the investor as an asset of his or her allocated pension. Money allocated to the ILRAC option in the allocated pension 862 is passed through to the ILRAC administration 870 and invested in unitised funds 872. In this fashion, an ILRAC investment may be made by way of a simple check-box and/or percentage allocation of total account balance and/or $ allocation within account structure.

A special data transfer interface 868 is set up between the allocated pension 862 and the ILRAC administration 870. This data transfer interface 868 passes customer and policy level information back and forward between the ILRAC 870 and the Allocated Pension product 862. When a benefit is payable to the investor, units in the ILRAC unitised funds 872 are sold and the cash returned to the allocated pension 862. Fees due to the Allocated Pension 868 and the adviser 2 may also settled by way of selling ILRAC units. Unit transactions are executed in the same fashion as for any other unit-priced wholesale fund 874—this feature minimises the need for expensive custom re-coding in allocated pension systems.

The benefits payable from the ILRAC product are as described with reference to FIG. 2A. Thus the ILRAC administration 870 maintains data to enable transfer of units to an unallocated account for subsequent distribution to surviving members of the corresponding ILRI pool. This may be effected by the ILRAC administration 870 passing batch instructions to the allocated pension 862 to sell units in the unitised funds 872 and redistribute units to surviving investors. This permits establishing a shadow unit registry system to enable individual customer level calculations and transactions to be processed external to the umbrella of a retirement income account product.

Method 800 of FIG. 9 describes in general terms the operation of the allocated pension 862.

To give effect to the ILRAC, an ILRAC interface 866 is provided in the Allocated Pension system 862. The operations performed by the ILRAC interface 866 may include:
Software to send customer and transaction level data to the ILRAC administration 870;
Software to accept account valuation information, unallocated unit distribution instructions and other information that the ILRAC system 870 needs to communicate to the allocated pension system 862;
Software to use the cash-surrender value 1430 of the ILRAC policy rather than the assets notionally allocated to the customer 718 as the current account value V for income max and min calculations in step 811 and step 813 and to use the assets notionally allocated to the customer 718 as a basis to calculate fees in 811 and 813
Software-based ‘hand-shaking’ rules between the allocated pension system 862 and the ILRAC administration system 870 to ensure that units are only sold in the ILRAC to make good on benefits 719 and 656 and for allocated pension fees in steps 811 and 809. These rules are important to ensure the Allocated Pension systems don't allow the sale of units for any reason other than to provide a valid benefit or fee payment. Erroneous unit sales could be difficult and costly to correct.
Software to accept data (including valuations and projected future incomes) from the ILRAC system 870 for inclusion into the Allocated Pension report 862.

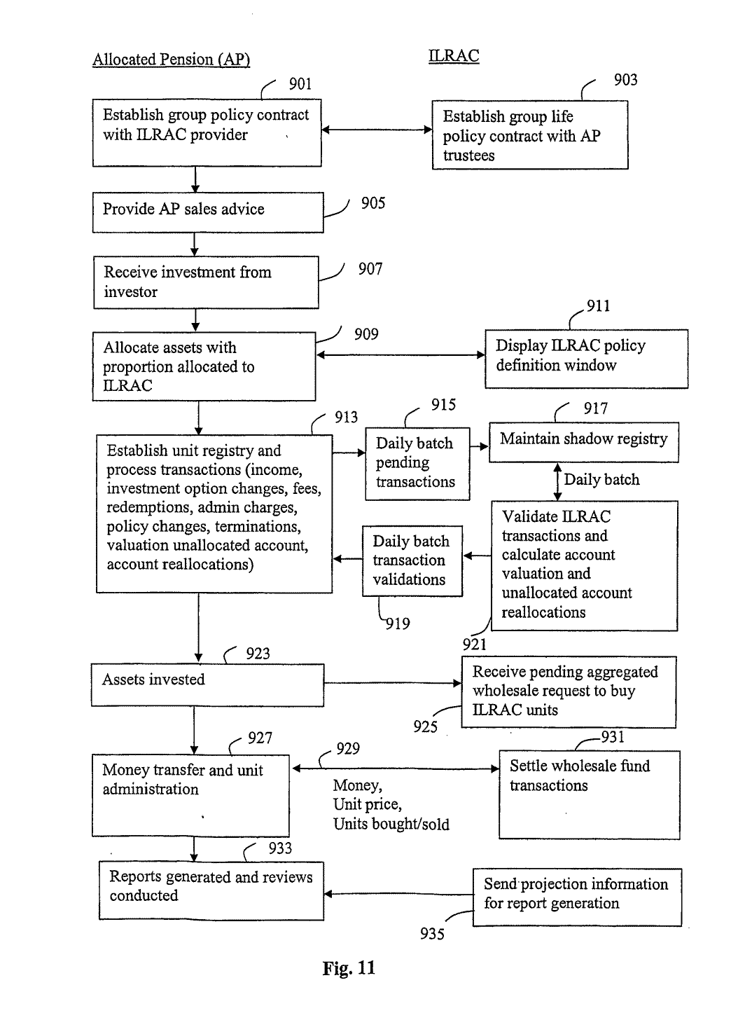

The joint operation of the Allocated Pension (“AP”) 862 and ILRAC 870 is illustrated in FIG. 11, in which steps 901, 905, 907, 909, 913, 923, 927 and 933 are steps associated with the AP 862. Steps 903, 911, 917, 921, 925, 929, 931 and 935 relate to the IRAC 870. In steps 901 and 903 a group life contract defining the terms of the ILRAC product is exchanged between the AP trustee and the ILRAC provider, where steps 901 and 903 reflect the actions of the AP and ILRAC respectively in establishing the group life policy contract. Steps 901 and 903 may also include a 3-way management services contract between the AP trustee, the ILRAC life company and an ILRAC product arranger and administration technology and service provider.

In step 905 the AP sales process is conducted, potentially incorporating the ILRAC Front End Sales Process technology described below.

In step 907 the AP 862 receives an investment 860 and in step 909 the investment is allocated to various investment options 856, 870 as illustrated in FIG. 10B. Where one of the chosen options is the ILRAC option 870, in step 911 an ILRAC policy window is displayed, for example on advisor unit 204 (and/or an additional section in a paper application form is accessed). The policy window is filled in with policy information (such as nature of death benefit, single/reversionary status etc). This step 911 also allows the ILRAC provider 870 to validate the rules associated with the ILRAC investment (for instance, there may be maximum limits to the proportion of AP funds invested in the ILRAC option).

In step 913 the AP provider 862 establishes a Unit Registry to track all customer holdings and transactions, which include income payments, changes to investment options, fees to be paid, redemptions and death benefits, administration charges, policy changes, terminations, valuations of the unallocated account and account reallocations. In step 915, the AP provider 862 sends the ILRAC provider 870, using an agreed data transfer mechanism and coding (i.e. data transfer 868), enough information for the ILRAC provider 870 to establish (in step 917) a “shadow” unit registry function. The information includes unique customer-level identifiers and a full set of pending ILRAC transactions. The transaction in step 915 may be ‘real-time’ or batched, for example on a daily basis.

In step 921 the ILRAC provider 870 validates the pending AP transactions and also calculates account valuation information and unallocated account transactions in the same fashion as described above for the Stand-alone ILRI product. The ILRAC provider 870 then, in step 919, sends a “hand-shaking” transaction confirmation back to the AP provider 862. This handshaking procedure also provides for exception handling. Steps 921 and 919 may be performed as daily batch operations.

In step 923 the AP provider 862 receives funds, aggregates the investments of multiple customer level transactions and sends the net investment instructions to all of the associated wholesale funds 856, 870. In step 925 the ILRAC provider 870 receives a pending aggregated wholesale unit transaction.

Then, in step 927 the AP provider 862 performs the pending transfer of money and performs the required unit administration. In the parallel step 931 the ILRAC provider 870 settles the wholesale fund transactions. As indicated by the arrow 929, monetary value is exchanged between the AP 862 and ILRAC provider 870, along with unit prices and details of the units bought and sold.

In step 933 the AP provider 862 generates reports for its investors and their advisers. In Step 935 the ILRAC provider 870 generates reporting information, such as projections, to be incorporated into the AP report.

The ILRI and ILRAC products can also be implemented in entirety by the retirement income product provider integrated within the retirement income product environment. Alternatively, it is also possible to perform all administration and reporting calculation steps inside the ILRAC application, potentially eliminating the need to replicate much of the ILRAC unit registry functions inside the retirement income product.

### Legislative Environment

The product structures described above may be implemented in different forms in different jurisdictions in order to increase the product efficiency in terms of taxation and social security legislation. The following section describes implementations that match the regulatory regimes operative in Australia as of the date of filing this patent specification.

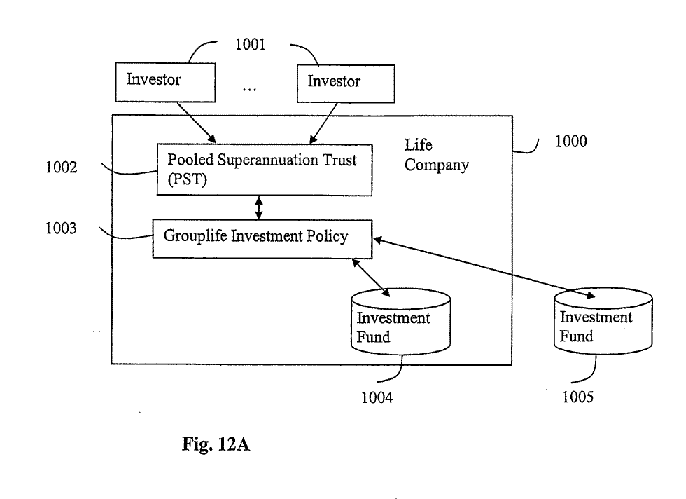

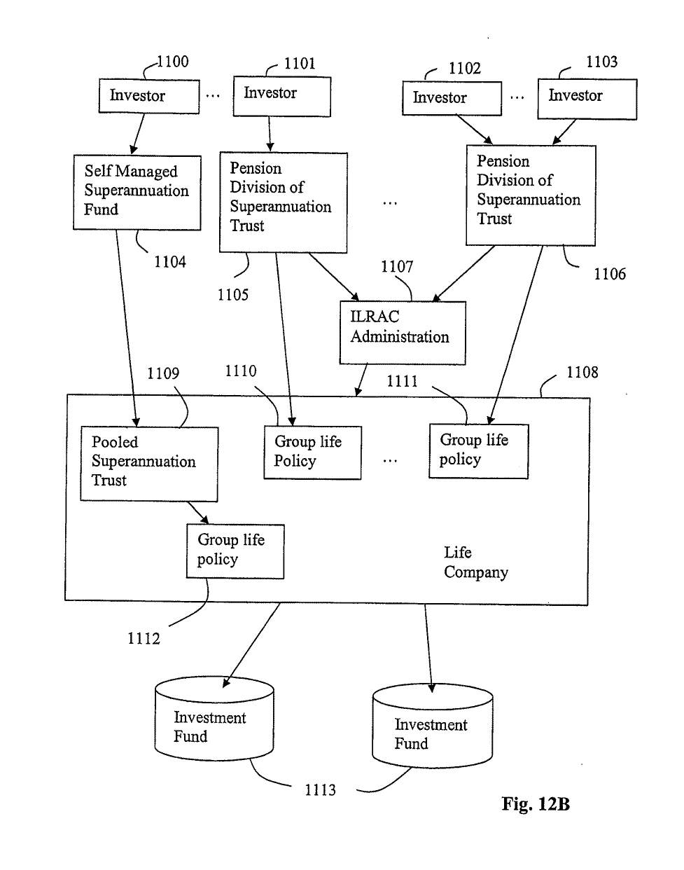

In FIG. 12A a Stand-Alone Product implementation is illustrated. In this implementation a Life Company 1000 allows investors 1001 to become members of a Pooled Superannuation Trust (PST) 1002. The Life Company 1000 also establishes a group life investment policy 1003 into which all assets received from customers are invested. The group life contract 1003 in turn invests the funds into internal investment funds 1004 or external investment funds 1005.

In FIG. 12B an ILRAC asset class product is illustrated. In this arrangement, investors 1100-1103 invest in public offer superannuation funds (e.g. Pension Divisions 1105-1106 of Superannuation Trusts) or Self Managed Superannuation Funds 1104. In the illustrated example, investor 1100 invests in self-managed fund 1104, investor 1101 invests in pension division 1105 and investors 1102 and 1103 invest in pension division 1106. The trustees of the public offer superannuation funds 1105-1106 enter into group life insurance contracts (e.g. 1110, 1111) offered by the Life Company 1108 and a three-way management services contract with the Life Company 1108 and the ILRAC administrator 1107. Trustees of the Self Managed Fund 1104 invest into accounts in a Pooled Superannuation Trust 1109 administered by the Life Company 1108 which in turn invests in a group life contract, e.g. 1112. The group life contracts 1110-1112 allow the Life company 1108 to invest in underlying investment funds 1113 at the direction of individual customers. The ILRAC administration 1107 administers an ILRI asset class as described above.

In respect of social security provisions, the ILRI products pay their benefits to the customer through the Allocated Pension. As a result the customer enjoys the same income test benefits as allocated pensions.

Regarding assets tests, the ILRI products are valued at the cash surrender value 1430 of the group life contract for each individual customer. Where this cash surrender value 1430 is lower than the notional account balance 718 it will be favourable from an assets test point of view. The “Legislative Value” will also be the value used to calculate the appropriate income draw-down level from the AP.

Other legislative product structures are also possible.

### Front End Sales Process

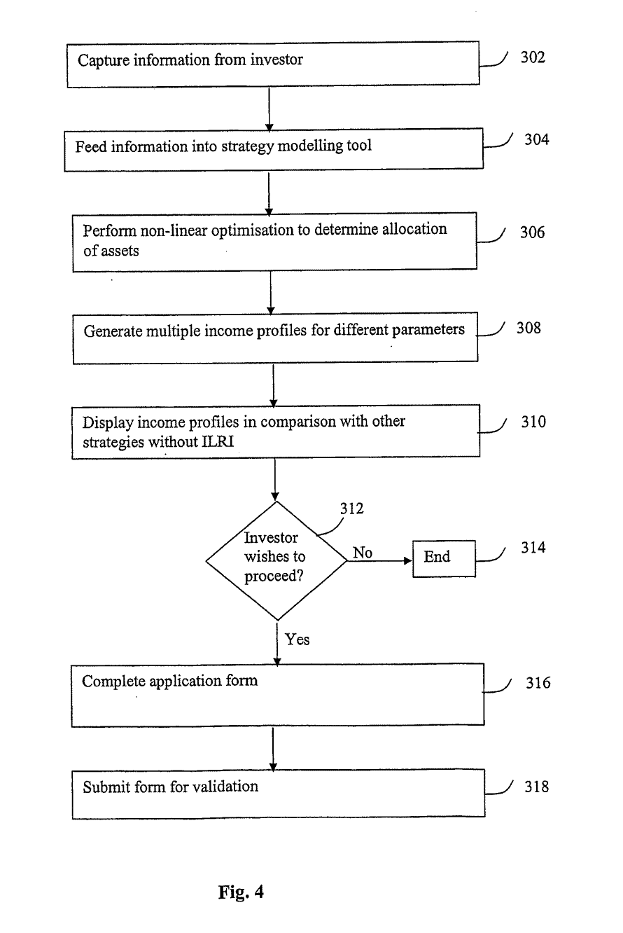

FIG. 4 illustrates a method in which a financial advisor introduces the ILRI product to a potential investor. The advisor may use software running on advisor unit 204 to support a presentation and to allow the investor to apply for an ILRI life policy. The advisor may also, via the Internet 206, access applications hosted on the ILRI technology platform 208.

In step 302 the advisor gathers basic information from the potential investor, including the ‘at investment’ risk factors, which typically include:
The age of the investor at investment;
Sex of the investor;
Product benefits and options selected by the investor (e.g. single-life or reversionary, early draw-down option);
Investment options selected by the investor; and
Other optional underwriting and pricing factors.

The information may be entered into the advisor unit 204 using a graphic user interface displayed on a display 414 of the unit 204. Information may be entered using, for example, a keyboard 402, mouse 403 or a touch screen

The advisor also gathers information concerning the asset base of the potential investor, together with the investor's retirement income goals and requirements. An assessment of the investor's risk profile may also be obtained.

In step 304 the advisor enters the gathered information into a strategy modelling tool, which may be implemented as software 207 running on the advisor unit 204 or on an application server 218. The strategy modelling tool performs a non-linear optimization to determine an appropriate division of the investor's assets between standard income-generating products (for example allocated pensions) and an ILRI product. The modelling tool may seek a quote from an application 219 running on the ILRI technology platform 208 for an ILRI target income ratio. The modelling tool includes local jurisdiction tax and social security calculations and includes modelling information about other product structures a retiree might aim to include in his or her retirement plan. In this way the modelling tool will enable the retiree to optimise their overall retirement income strategy.

In step 308 the modelling tool produces one or more income profiles based on different input parameters, for example the selected investment risk category, start date of the survival benefit and the ratio of early and late retirement income.

The ILRI life policy may be configured such that survival benefit payments are deferred until there is less than a 60% chance of survival and the mortality rates applicable to the investor are increasing rapidly. In this event, the funds which need to be allocated to fund the ILRI product in order to achieve a target level of income are kept low. The investor may thus allocate remaining funds to other income products that serve to meet the investor's needs earlier in retirement.

In step 310 the one or more income profiles generated by the strategy modelling tool are displayed to the investor, for example on the display 414 of the advisor unit 204. Such profiles may assist the potential investors to better understand the otherwise complex pricing proposition. An example of the income strategy comparisons is shown in FIG. 15. This figure shows a conservative income strategy 1510 and an aggressive income strategy 1520 without the ILRI product in the strategy. On the same graph it compares the total income strategy with the ILRI included 1550 and shows how it is made up of age pension and standard asset income 1530 and the ILRI income 1520. These comparisons demonstrate the clear income value proposition offered by the ILRI product.

The displays available for display on the advisor unit 204 also illustrate the predicted survival rates at various ages. The strategy tool allows variation of parameters and provides a recalculation and re-projection to show the impact of different strategies. At any point the advisor may store information for later retrieval. Data may be stored within the advisor unit 204 in memory 406 or storage devices 409. In addition or alternatively, the data may be transferred over the Internet 206 for storage in databases 216.

In step 312 the potential investor has the choice of proceeding with an application for an ILRI life policy, for example by clicking on a “Buy” button displayed on the advisor unit 204. If the investor does not choose to proceed, the process ends in step 314. If the investor does proceed, an application form is automatically populated with information gathered in earlier steps. Smart forms are used to ensure that the advisor validates all the populated information. The smart form displays prompts requesting additional information, such as bank details and a user signature. Populating and completing the application form constitutes step 316.

Once the form is complete, in step 318 the form is submitted to the ILRI technology platform, for example via the Internet 206. An electronic validation of the sales process is completed.

### Managing Investment Pools

One aspect of the ILRI and ILRAC products is the ability provided to the investor to select his or her own investment strategy and to change that strategy over time. This is understood to be unique amongst pooled risk products. Another feature of the ILRI and ILRAC products accrues from methods to create larger pools of lives by pooling across the policies established by different trustee customers.

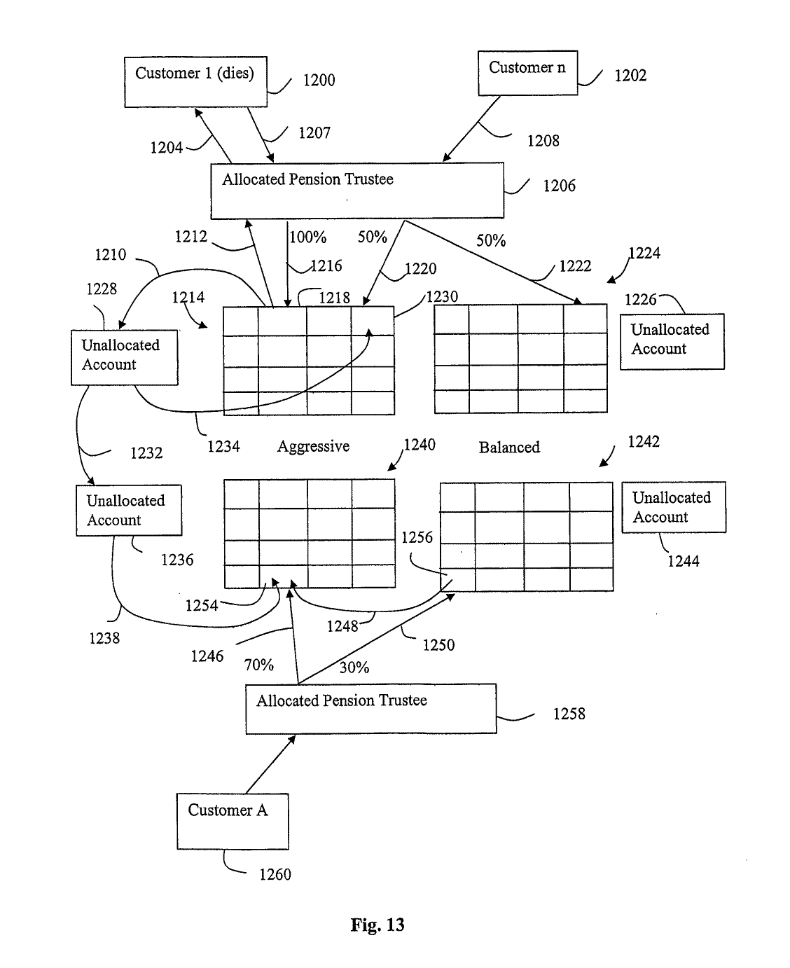

The pooling methods have two aims. One aim is to isolate the impact of investment performance of each pool solely to those who have invested in the pool. Because the value of longevity bonuses varies with pool performance it is desirable to isolate the pooling effect to each asset class. The second aim is to allow customers to switch between options. FIG. 13 illustrates these operations. Customer 1 1200 invests 1207 through Allocated Pension Trustee 1206 into an aggressive investment pool 1214 that is part of an ILRAC product. Customer 1200 opts to invest 100% in the aggressive pool 1214, as illustrated by arrow 1216.

The ILRAC provider sets up an Unallocated Account 1228 for the aggressive investment pool 1214. The unallocated account 1228 is mirrored in the AP trustee's systems 1206. The pool 1214 is depicted as a grid in which each square represents a notional account for a customer in that investment option. A square 1218 represents the account of customer 1200 and a square 1230 represents the account of customer 1202 in the aggressive investment option.

Customer 1202 invests 1208 through AP trustee 1206, opting to invest 50% in the aggressive investment pool 1214 (denoted by arrow 1220) and 50% (denoted by arrow 1222) in a balanced investment pool 1224 that is part of the ILRI product and has an associated unallocated account 1226.

If Customer 1200 dies, a death benefit 1212 is paid from the pool 1214 to the trustee 1216 and then on 1204 to the estate of Customer 1200. The remaining notional account balance in account 1218 is then transferred to the unallocated account 1228 (cashflows 1210). Periodically the unallocated account 1228 is cleared by paying a Longevity bonus to the surviving pool member (in this case Customer 1202) as described above. Arrow 1234 depicts the cashflow from unallocated account 1228 to the notional account 1230 of customer 1202.

Another allocated pension trustee 1258 maintains aggressive investment pool 1240 (having unallocated account 1238) and balanced investment pool 1242 (having unallocated account 1244). Note that under this arrangement the pools for Trustee 1206 and Trustee 1258 are maintained separately. This reduces the effective pool size and increases the benefit volatility for members, a commercial disadvantage. By establishing a Cross-Trust Pooling benefit, akin to reinsurance (cashflow 1232 between unallocated account 1228 associated with pool 1214 and unallocated account 1236 associated with pool 1240) the pools may be linked. The cross-trust pooling calculation works by calculating pool-level aggregate risk statistics, R, as described in the text above. Under this arrangement the cashflow 1232 occurs before each pool's unallocated accounts 1228, 1238 are cleared and ensures that customers with the same individual risk statistic value receive equivalent Longevity Bonus no matter which Trustee 1206 1258 they are invested through. This mechanism increases the effective pool size. Thus, customer A 1260, who invests in aggressive investment pool 1240 through trustee 1258, also receives a longevity bonus (cashflow 1238) consequent on the death of customer 1200. Square 1254 represents the notional account of customer A 1260 in aggressive pool 1240. Cashflow 1238 flows from the unallocated account 1236 to the account 1254.

Also illustrated is the mechanism for changing investment strategy. Customer A 1260 decides to move from an original strategy of 70% Aggressive (denoted by arrow 1246), 30% Balanced (denoted by arrow 1250) to 100% Aggressive. She does this by selling the 30% balanced units 1256 at that day's unit price and using the proceeds to buy the same value's worth of Aggressive units (denoted by unit purchase 1248 between account 1256 and account 1254). Note that the ILRAC system keeps track of the dollar-time-weighted risk statistic for Customer A 1260. For example, despite potentially selling out of the balanced pool 1242 part way through the period in which the unallocated account 1244 is building, customer A 1260 will receive a portion of the unallocated account Longevity Bonus at the end of that period as determined by customer A's risk statistic value in that pool 1242. This approach affords flexible, fluid changing of investment strategy across a range of options by transacting at a unit price and by maintaining a time-weighted, risk weighted, dollar weighted risk exposure metric for all pools a customer has participated in during the period between unallocated account clearing events

### Performance Fees

As described above, in the ILRI and ILRAC product investors retain group mortality risk. Since the investors rely, at least to some extent, on the mortality assumptions and projections of the product issuer or arranger to understand the likely performance of the product, it may be attractive for the product issuer or arranger (Provider) to charge a performance related fee for their services. An implementation in which the performance fee is linked to the actual versus projected longevity bonus distribution at any point in time is proposed. This aligns the interests of the Provider and the investor, since if the Provider over-estimates the level of longevity bonus that will accrue to the investor (for instance to improve the pricing and commercial competitiveness of the product in the market), then the Provider's fee rate will fall as mortality experience yields lower longevity bonuses. This arrangement would be implemented through the following step of steps:
1. The Provider would determine the apriori expected Longevity Bonus Unit distribution schedule—E(LB U, t)
2. The Provider would determine a fee rate structure, likely to be made up of a fixed component—F_{fixed}—and a performance-linked component—F_{perf}
3. As the mortality performance unfolds, the actual Longevity Bonus Unit distributions would be determined at certain points in time—A(LBU,t).
4. The fee rate for the Provider could then be determined as:

$$F ( t ) = {F}_{fixed} + {F}_{perf} \frac{A ( LBU , t )}{E ( LBU , t )} \qquad ( Equation 3 )$$

### Policy Written as a Rider

As described with reference to FIG. 1, the investor pays a single premium. Other premium structures may be used. In one alternative arrangement the ILRI contract may be written as a ‘rider’ on a standard allocated pension. In this case, annual premiums may be automatically deducted from the allocated pension to fund the ILRI.

The advantage of this system is that it is simpler for the investor and locks less capital away early in the contract. The structure may also be advantageous for product manufacturers wishing to ‘build’ a completely integrated retirement product.

### Methodologies for Lowering Critical Pooling Risks

The ILRI product is a highly efficient mechanism for customers to reduce critical retirement strategy risks. By pooling stochastic risk (ie. individual life length uncertainty) customers are able to diversify away one of the major risks to which they are exposed. Furthermore, by accepting all systematic risks, the customers can achieve the pooling diversification while maintaining attractive expected returns.

Having said this, the product, in its purest “pooling-only” form, can potentially expose customers to more risk than may they wish to take. Several of these risk families are outlined below:
Small numbers risk: When the number of customers in a pool is low, the stochastic uncertainty of actual versus expected death rates can lead to instability in the payout of the pool. There a number of scenarios in which small numbers risks can occur:
   when the product is first sold there are clearly zero members;
   when any new investment pool is established, it is possible that there are no initial members;
   when the product, and/or any particular pool is in run-off mode the number of surviving members will eventually be small;
Selection assumption basis risk: This is the risk that participants purchasing this product are only those who have accurate knowledge that they will live much longer than average. This effect will, of course, occur to some extent and is well documented in the sale of annuity style products. Typically, with annuity style products, the life company accepts this risk and prices the risk into the product. Similarly, the ILRI product views the selection risk as being a “true cost” of issuing the product. In the “pooling-only” form of ILRI products, customers bear this true cost, however it also comes with added uncertainty, since, apriori, the actual cost can only be estimated.—This uncertainty may be termed the selection assumption basis risk. One of the innovations of the ILRI products is to provide customers guidance on the expected impact of the selection risk by communicating expected future pay-outs based on a model which incorporates selection that has, in the first evolution of the product, been experienced in similar product such as life-time annuities, and, as experience in the product evolves, is the risk experienced in this actual product. In this way, the risk borne by the customer is the “basis risk” that the group of customer's mortality experience deviates from the reference group used to generate the pricing assumptions (ie. the reference group is initially annuitants and subsequently current pool members).
Long term group longevity improvement risk: Another uncertainty customers accept in the ILRI product is the uncertainty around the extent to which group longevity will improve over time. Group longevity improvements are driven by a complex array of social, medical, demographic and selection factors. Historically, mortality rates (and hence longevity) have improved quite quickly and somewhat unpredictably. The historically poor ability of Life companies to accurately predict improvements in future rates of mortality is one of the key factors driving the expensive actuarial reserves which must accompany long-term lifetime guarantee products. One of the key innovations of the ILRI product is to provide a mechanism whereby the issuing company is not exposed to “long-tailed group mortality risks”—based on the belief that this long-tailed, un-diversifiable risk is best broken-up and “owned” by a large group of small customers rather than concentrated into one institution. When separated out, and considered in isolation from long-term investment risk, however, it is conceivable that guarantees may become practical and attractive.
Long-term investment risk: In traditional annuity products, the Life Company accepts and invests premiums to pay future benefits. It is in the interests of prudential regulatory authorities to ensure that the Life Companies adopt conservative investment strategies to enable them to meet their long-term relatively fixed obligations. This has lead to conservative predominantly fixed interest asset-liability matching strategies. The ILRI product gives the customer, who is willing to accept some risk in the end income level, the option to invest more freely by “owning” their investment performance risk. This can have a huge impact on the expected performance of the product.

In this section, innovations, methods and systems are presented for managing the ILRI pool in the face of these uncertainties and providing options for cost- and capital-effectively ameliorating the impact of certain specific, isolated elements of these risks. These innovations have significant commercial value, potentially making the ILRI product suite a significantly more attractive proposition to customers.

Small Numbers Risk: The issue of small numbers volatility is a particularly important one. It is easy for customers and advisers to visualise the potential volatility caused by joining a pool with too few members to be statistically stable. For this reason solving this problem is important for preferred implementation of the ILRI product.

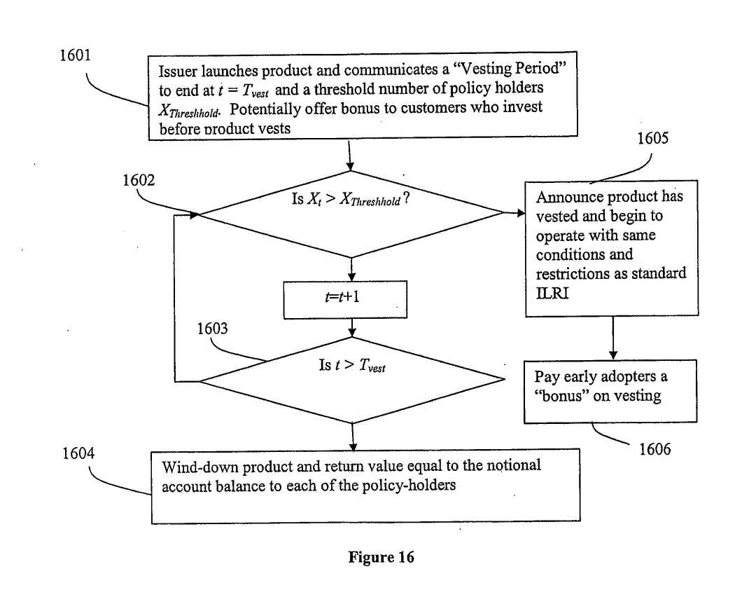

Pool vesting: One simple innovation addressing this issue is ‘pool vesting’ and is illustrated in FIG. 16. In this case, the issuer communicates a ‘vesting period’ to customers 1601, and potentially offers a vesting bonus to early adopters. During this period the issuer attempts to build statistically and commercially viable scale for their product 1602. If this scale is not reached by the time the vesting period has elapsed 1603, the issuer reserves the right to close-down the product and return the full current capital value invested to customers 1604. The specific terms could be varied to deal with fees and the possibility of a customer having died during the vesting period. If scale is reached, the product terms and conditions lock-in and the product proceeds as originally conceived 1605. It may be useful to pay an “early-adopter bonus” 1606 of some sort to customers who invest during the vesting period to reward them for helping the product and company get to scale.

Small Numbers Risk Insurance (SMRI): Another method for dealing with this issue, which is more general and potentially eliminates an “awkward” sales conversation associated with vesting above, is to provide a guarantee that the product will “operate as if it had at least x starting customers from day 1”. A similar approach can be used to guarantee cash-flow stability during a potential run-off phase. In this case, x would be set to a level that provides reasonably low stochastic volatility but which can hopefully be achieved quite quickly. Numerical modelling suggests a number such as 1000 customers may be appropriate.

A further implementation describes a method for providing such a guarantee without exposing the guarantor to potentially very costly long-term systematic risks. This innovation is significant, and generalisations of it have application in many areas of the retirement incomes, reverse mortgage and insurance markets. A particular implementation involving the issuer establishing a reserving pool is described. Based on this description, those skilled in the art will recognise a number of other ways of achieving the desired result, for instance by establishing reinsurance contracts to perform similar functions.

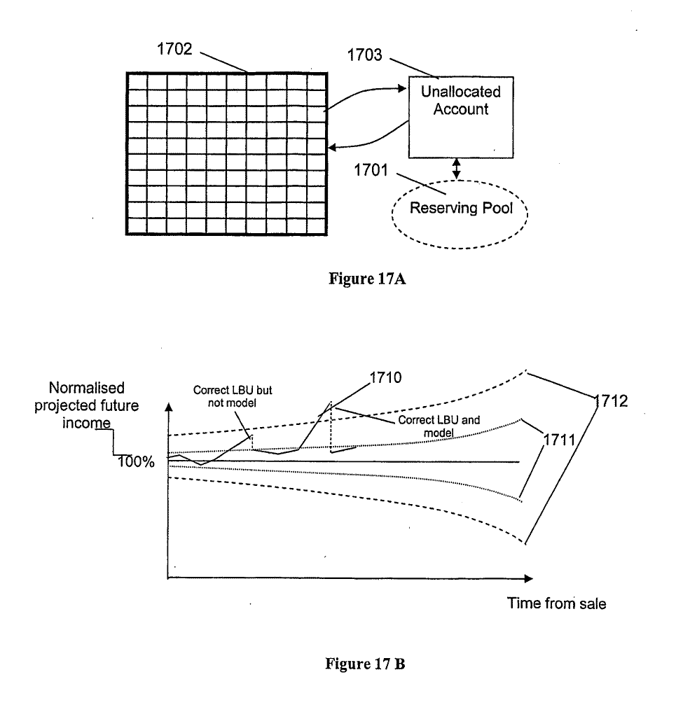

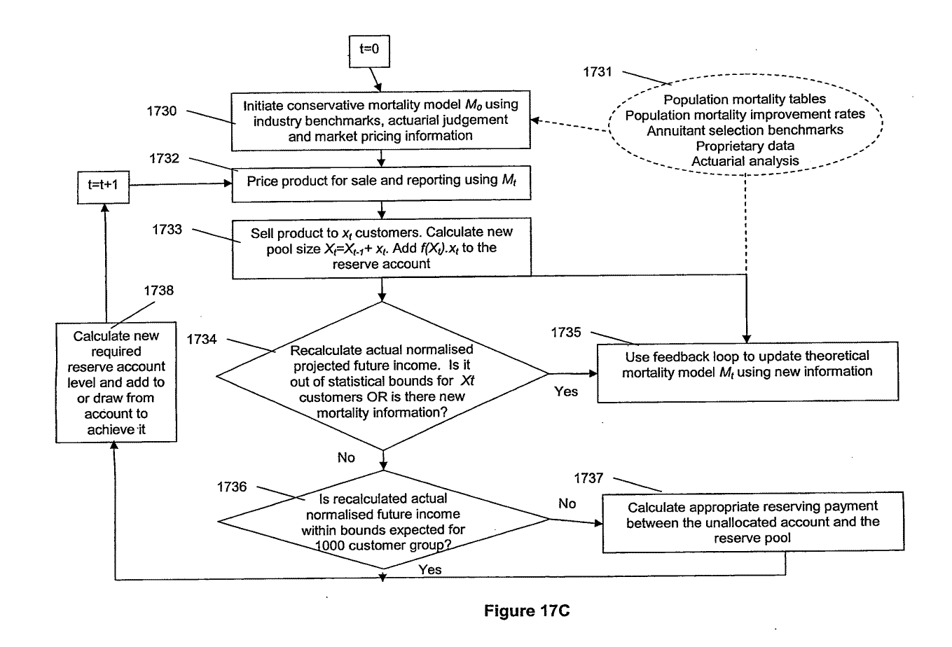

The method is illustrated in FIGS. 17A, 17B and 17C. FIG. 17A illustrates an arrangement where a reserving pool 1701 is added to an ILRI pool 1702 and an Unallocated Account 1703 arrangement as described and illustrated in detail above. FIG. 17B qualitatively illustrates the type of insurance guarantee that is currently proposed. First appropriate metrics of performance are selected. The first key metric is the current projected future income level to be drawn from the pool given actual investment and mortality experience (calculation of which is described earlier in the text), divided by the projected future income level to be drawn from the pool given actual investment and the theoretical model mortality experience 1710. This metric is independent of investment performance but varies as actual mortality experience deviates from the model mortality performance. Numerical modelling can be used to calculate curves 1711 and 1712 that represent the small-numbers volatility that can be expected in this metric over time from a product with different numbers of customers. Curves 1711 represent the upper and lower bounds containing 95% of outcomes for the normalised projected income metric in the case that the group has 1000 customers. Say there are currently 100 customers who have purchased the product, then Curves 1712 represent probability bounds including 65% of likely outcomes. The proposed guarantee works as follows. If the actual mortality experience falls outside (ie. below or above) the 95% bound expected if the group had 1000 customers, a payment to (from) the unallocated account from (to) the reserve pool is paid to move the actual projection back within the 95% bounds. If the actual performance falls within the 65% bounds represented by Curves 1712 then there is unlikely to be statistically significant information about a systematic basis error in the underlying mortality projections and the actual experience information is not used to adjust the mortality model. If, however, then actual performance falls outside the 65% bounds, this is likely to indicate that the model is in error—as described below, this information is fed-back into an algorithm that updates the model.

The business method for operating SMRI is illustrated in flow diagram of FIG. 17C. The flow diagram may, in one implementation, be programmed into the ILRAC administration system 870. The cash-flows 1704 between the unallocated account and the reserve account would likely be legally classified as an additional class of policy benefit under the group life policy.

FIG. 17C starts from time, t=0. In Step 1730, the issuer establishes a mortality model, or mortality table, Mₜ₌₀. Typically, the model will be based on a range of factors and actuarial judgement illustrated by the list 1731 which is not intended to be exhaustive, this including population mortality tables, population mortality improvement rates, annuitant selection benchmarks proprietary data, and actuarial analysis. The issuer faces a healthy tension between being conservative (ie. predict lower mortality) and its desire to increase the projected income it offers in the market. In Step 1732 the product is priced based on the latest mortality table Mₜ and product is sold to the customers in Step 1733. As product is sold, an amount is added to the reserving pool for each new customer (ie. the pool is recalculated). The amount per customer is dependant on actuarial calculations and judgement and will decrease as the total number of customers in the pool increases.

In Step 1734 the actual projected normalised income is compared with the statistical bounds expected for the current number of people in the pool. If it is out of the statistical bounds, or if there is significant new external information 1731, a feedback loop is used to update the mortality table Mₜ. This step limits the product issuer's exposure to systematic shifts or mis-estimates of the mortality table, while still allowing it to smooth out the small numbers volatility in the pool.

In Step 1736, the actual projected normalised income is compared to the 95% expectation bounds for the same metric with a pool of 1000 customers. If it is out of bounds (either higher or lower), an amount is transferred (either positive or negative) from the unallocated account to the reserving pool. Step 1737 happens prior to the unallocated account being cleared as described in Step 109 of FIG. 2A.

In Step 1738, the issuer ensures that the reserve account is maintained at the appropriate level by applying actuarial calculations. This may result in the issuer releasing cash from or adding cash to the reserve account.

### Selection Assumption Basis Risk

Investors in the group may determine that they wish to off-load the selection assumption basis risk. In this event, the issuer may use a methodology similar to that described above with the exceptions that:
in Step 1730 it may begin with more conservative assumptions;
in Step 1735, it may restrict the feedback loop and mortality model structure to exclude selection risk updating. Note that the technique still allows the mortality model to be updated with new information reflecting the improvement in the mortality of the population as a whole. This goes a long way to immunising the product issuer from a critical long-term risk and can represent a significant innovation in retirement income guarantees offered to customers;
in Step 1736, it may compare the actual normalised future income projection metric to a metric that represents the statistical bounds for (i) the current number of participants in the group (this would eliminate SMRI) or (ii) the minimum of the current number of participants in the group and the guarantee level (eg 1000) offered in the SMRI guarantee.
Adding this feature can allow the product to be marketed with the claim that the customer's returns are insulated from exposure to the selection bias of the other customers who buy into the pool.

### Guaranteed Unit-Level Returns

The issuer may also go a step further. In this case they may issue a guaranteed “worst-case” mortality table—communicated as a minimum LBU return over the course of the product. They may set the mortality basis up-front or allow the mortality basis to float, but to be bounded such that customers receive a certain minimum number of LBU no matter what happens to pool mortality. Providing such a guarantee will require significant reserving unless it is well out of the money however it may be attractive. Note that unlike traditional annuity structures, such a product would not require long-term investment return guarantees. Since it is long term investment guarantees that drive much of the reserving requirement and the very conservative approach to investment, delivering a product that strips this away, but provides pooling certainty may be extremely attractive.

This guarantee innovation may be implemented in several ways. One method is similar to flow diagram FIG. 17C, except that in step 1734 the mortality table is either bounded by the guaranteed mortality table (in the event that the mortality table is allowed to float) or is not changed at all. In Step 1736, the actual LBU's in the unallocated account are compared with the LBU's that have been guaranteed and in Step 1737 transfers to and from the reserve pool ensure the customers achieve the guaranteed LBU allocation outcome. The reserve pool is invested in the same assets as the LBU's will be credited in, ensuring no long term investment risk mismatch.

### Option to Convert to Annuity

The ILRI provider may offer an option for the investor who has reached the survival age, to roll his or her notional account balance funds into a life-time annuity. One arrangement creates a market of life-time annuities managed by the ILRI product provider. The ILRI product provider sets the allowable terms of the annuities and may charge a commission on funds rolled into the structures. It may be possible to provide annuities at better than normal market rates because the ILRI provider will have additional underwriting and mortality curve information for the relevant customers, having had them on their books for a long period of time.

In order to eliminate the introduction of selection into the pool (i.e. the withdrawal of investors having a low survival probability), the roll-over is mandated to be into a non-commutable lifetime annuity that has a residual capital value of zero (or sufficiently close to zero).

In order to avoid the obligation to hold capital, the policy terms would only reflect the right to roll funds into an annuity, should the investor be able to find an annuity on offer at that point. If the investor cannot find a suitable annuity, then the standard contractual survival benefit pay-out for the ILRI product would persist instead.

Through this definition of terms, the policy can be offered in a significantly more capital-efficient manner than has some existing retirement products.

### Option to Bring Forward Annuity Start Date by Several Years

Using the ILRI pricing (table 262) technology the option to start the annuity several years early can be priced. One potential method is to use the pricing technology to establish a modified mortality table reflecting the increased likelihood that someone who starts the annuity early knows accurate adverse personal survival information. The expected present value of future cash flows to the investor based on this modified table and without changing the start date of the annuity is calculated, FV_{no change}. The same value is then calculated using the modified mortality table and bringing forward the start date of the annuity FV_{early start date}. Initially this value FV_{early start date}>FV_{no change}. An iterative solve or other method may then be used to reduce the notional account balance in the second calculation to a point where FV_{early start date}=FV_{no change}. If the investor accepts the reduced pricing and brings forward the annuity start date, the excess notional account balance is transferred to the unallocated account for redistribution to all surviving members. Once the balance has been reduced in this fashion, all future projections and calculations may be conducted using the unmodified mortality table. In this way investors can be given the option of an early start date, but unfair selection biases can be reduced. Other actuarially acceptable methods to achieve the same innovation are also possible.

Comparison of ILRI Product with Prior Art Products

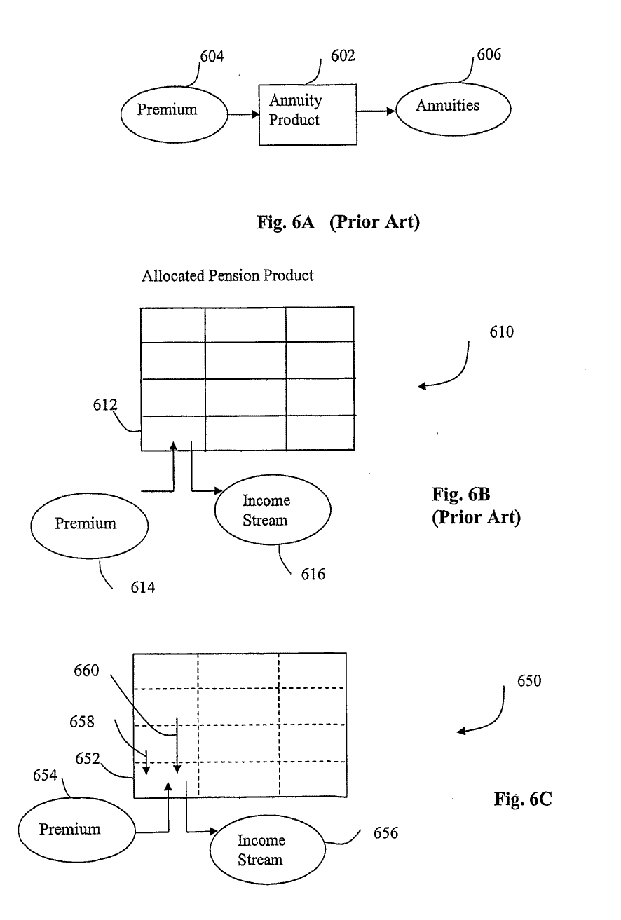

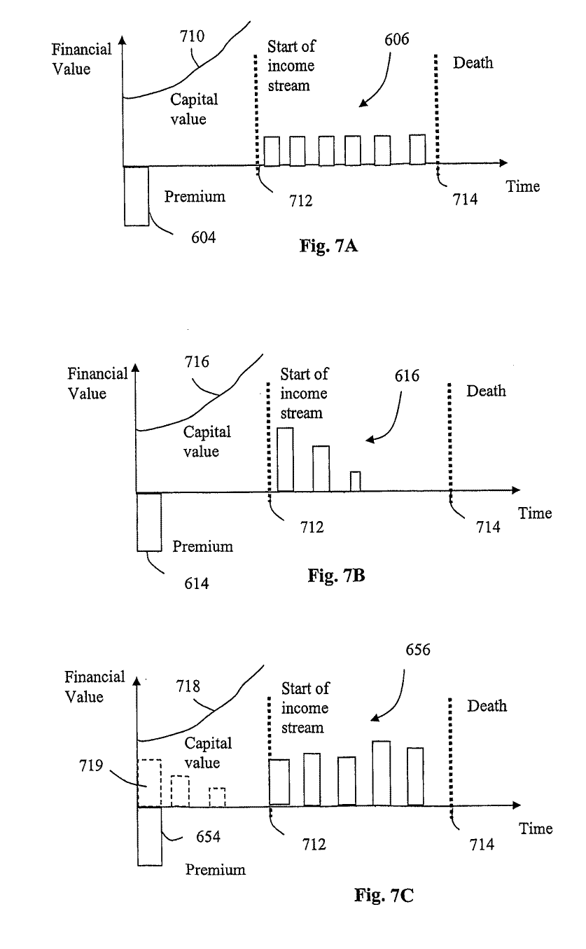

FIGS. 6A-6C and 7A to 7C provide a comparison of the structure of the ILRI life policy described herein with prior art annuity and allocated pension structures.

An annuity product 602 is illustrated in FIG. 6A. An investor pays a premium 604 (either as a once-off payment or as a plurality of payments) and, possibly after some lapsed time, an annuity stream is paid to the investor for the remainder of the investor's life. FIG. 7A shows a schematic graph of financial value (on a y-axis) versus time (on an x-axis). Initially, the annuity provider receives the premium 604, which is invested forming a capital value 710 that is expected to grow in value with time. From a commencement date 712, annuities 606 are paid to the investor until the date 714 of the investor's death. The annuity structure benefits from the pooling of uncertainty associated with individual longevity, as those investors that die sooner cross-subsidise those that live longer. Because of the cost of providing life-time guarantees and complying with regulations concerning cash reserves, the annuity structure is not capital-efficient, which limits the value of the annuities 606.

Annuity vehicles provide implicit guarantees of one type or another which for which reserves must be maintained. They are also “black box” vehicles in which the Life Office actuary has significant discretion to determine pricing and investment strategy. This limits investor flexibility and control, and has a significant impact on the commercial appeal of annuities.

FIGS. 6B and 7B illustrate the prior art allocated pension structure 610. The investor invests a premium 614 (either as a once-off payment or as a plurality of payments) in a corresponding account 612 of the allocated pension structure 610. The capital value 716 of the invested account is expected to grow with time due to returns on investment. Some efficiencies are obtained because the allocated pension structure may have considerable funds to invest. Because of the account structure, the investor may be provided a clear indication of the value of the investment account 612. After the start date 712, an income stream 616 is provided to the investor until funds available in the account 612 are exhausted, which may be many years before the investor's death 714. As illustrated in FIG. 7B, the income stream 616 potentially declines to zero before the investor's death 714.

The ILRI life policy described herein is illustrated in FIGS. 6C and 7C. The investor pays one or more premiums 654 into an account 652 within the investment pool 650. Capital growth is expected due to returns on investment. In addition, units are distributed into account 652 from accounts of deceased investors in the investment pool 650 (e.g. distributions 658, 660). Such distributions 658, 660 together with investment performance contribute to the growing capital value 718. The structure 650 thus benefits from a pooling of individual longevity risks. After the start date 712 (which corresponds to the survival age specified for the investor), an income stream 656 is provided to the investor until his or her death 714. Because of the cross-subsidisation and pooling of risk, the income stream 656 is expected to persist until the investor's death 714. The ILRI structure does not require the same level of cash reserves as an annuity product 602 since the ILRI policy does not provide the same guarantees. The ILRI product also allows for a death benefit 1420 and a variable cash surrender value 1430.

### Product Modifications to Allow the Efficient Release of Home Equity

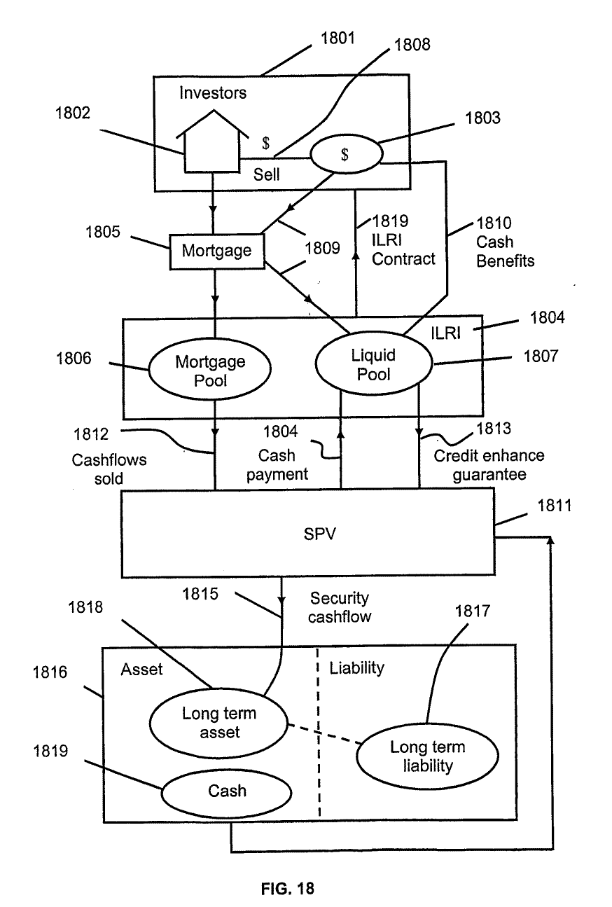

A system for extending the core ILRI concept to providing efficient release of home equity and for matching long-term longevity-hedged securities is illustrated in FIG. 18. Instead of investing a cash premium into the ILRI product investment pool, it is possible for investors 1801 to contribute a mortgage obligation (“Mortgage”) 1805 secured against some other asset, such as their house 1802 (hybrid cash and mortgage contributions are also possible). Unlike typical home loan or reverse mortgages, the investor would not receive an immediate cash loan amount. Instead, they would secure an ILRI contract 1819 which would pay them survival benefits 1810 each payment period they survive beyond the survival age. The ILRI product provider 1804 maintains a pool of Mortgages 1806 and one or more liquid asset pools 1807 as described above. When the investor dies, sells their house or wishes to refinance 1808 their mortgage, the investor pays the outstanding cash to the ILRI product provider 1809 who debits the Mortgage contract pool 1806 and credits the liquid pool(s) 1807 by the cash amount paid. When individual investors reach the survival age, survival benefits are determined by the ILRI product provider and paid out of the liquid asset pools 1810.

Depending on the mortality of investors and the repayment schedule on Mortgages, it is conceivable that at any point in time the ILRI product provider may not have sufficient liquid assets to meet cash benefit obligations. In this case, and indeed for other reasons also, the ILRI product provider may arrange to securitise the Mortgage obligations into a Special Purpose Vehicle (“SPV”) 1811 and sell them to other investors. By carefully structuring the Mortgage Pool cashflows 1812 and optionally adding credit enhancement 1813 backed by the liquid pool, it may be possible to create securities whose cashflows 1815 closely match long-term longevity-risk-exposed liabilities 1817, such as those held by many annuity providers. Investors exposed to such liabilities will be prepared to pay attractive prices 1820 for these securities, thereby providing the ILRI product provider with substantial liquid assets 1814 to offer as attractive survival benefits to its investors.

Following is a discussion of certain of these innovations in more detail.

### Mortgage Contracts

The appropriate configuration of the mortgage contracts is important to commercial success of this proposition. The contracts must be simple, clear and “safe” for customers. However, they must be appropriately structured to allow the securitisation proceeds to be maximised. An example of the debt obligation terms for a mortgage contract follows:

$${D}_{i} = {\sum }_{all i} {P}_{i} and {P}_{i} = {P}_{i - 1} \times ( 1 + {CPI}_{i} + δ ) \\ for i < SurvivalAge and \text{:} \\ {D}_{i} = {D}_{SurvivalAge} \times {\prod }_{i > SurvivalAge} ( 1 + {CPI}_{i} + δ ) \qquad ( Equation 4 )$$

where:
i is the years since contract start;
Dᵢ is the debt obligation in year I;
P is the ILRI “premium”;
CPIᵢ is the consumer price index in year and
δ is a small interest rate premium.

This contract provides for an annual ILRI premium added to the debt each year until the survival age. The Premium increases at slightly above the consumer price index (CPI). After the Survival Age, the debt escalates at slightly above CPI (ie. no new premiums are added). Given that it is widely felt that house values are likely to appreciate in real terms, P can be set such that only a “knowable” proportion of end house value could ever be due.

The benefit of this contract is that it replicates the annual premium version of the ILRI prior to the survival age. Beyond the survival age, it becomes like a secured guarantee to CPI-linked zero-coupon bond (“zero”), which matures on the death of the customer/investor. As long term CPI-linked zero's are in short supply it is likely that pools of such contracts may have value in the market. The contract is, however, closely linked with the longevity of its holders. If we assume that contracts are held until death then the zero's will form a stream of cashflows shaped by the number of deaths occurring each year. Partly because the number of deaths occurring at any particular age is a function of the number of people of that age alive, after the age expectancy of a cohort (group of survivors) is reached, that stream of cashflows from the mortgage contracts is a good hedge against a stream of CPI-linked annuity payments to survivors. As discussed below, this feature provides the opportunity to construct securities which can pay long-term, CPI-linked annuitant longevity hedges. These securities should attract high prices, particularly from life companies exposed to annuity liabilities.

As a final note, it is possible to set δ such that additional guarantees can be funded. These guarantees would provide protection in the event, for instance, of significant shifts in group mortality. It is possible that δ could accrue to the ILRI provider if mortality experience emerges more favourably.

### Managing the Mortgage and Liquid Pools

The Mortgage and Liquid Pools may be managed in much the same way as for the standard ILRI product. When determining the appropriate survival benefits, it is necessary to model forward all likely future cashflows to and between pools. The approach described above can easily be generalised to cope with this.

Product design decisions include the level of control and visibility investors have over their notional mortgage pool and liquid asset holdings.

### Securitisation

To illustrate the securitisation approach, consider the mortgage contracts proposed above. The future cashflows from these mortgages can “split”. Any mortgage contract that pays out due to death prior to the Survival Age is “owned” by the Mortgage pool 1806. Any mortgage contract that pays out due to death after the Survival Age is “sold” to the SPV 1811, less the component relating to the interest rate premium δ. As noted above, these cashflows represent a CPI-linked hedge against annuitant deferred long-term annuity liabilities. It is also possible to “credit enhance” these cashflows. For instance, by ensuring that contracts that are not held to term, cashflows from the liquid pool are used to mimic them. In this way life insurance companies may be prepared to pay a high price 1820 at the time the mortgage 1805 is taken, which will be passed through to the Liquid Pool. If this cash is invested it may be possible to earn returns which yield higher expected survival benefits depending on the risk profile of investors.

Since the cashflows, resulting over time from a pool of mortgages that investors have contribute to ILRI, may be projected and optimised to closely match the liabilities of third parties, the third parties may be prepared to invest to receive future cashflows. Those third parties may demand a rate of return on investment significantly lower than that typically demanded for standard reverse mortgage pools. Put differently, the third parties may be prepared to pay an attractive price now for an interest in the future cashflows. Accordingly this affords an arbitrage opportunity to reinvest the proceeds of the sale to create a higher income than might otherwise be achieved to be distributed to investors in the ILRI or ILRAC. Additionally, the optimised cashflows may be generated using mortgage contracts which accumulate interest at a significantly lower rate than traditional reverse mortgage contracts. The interest rate may be at a rate at least 50 basis points less than the standard market mortgage rate.

The mortgage arrangements described above, afford a number of valuable commercial products, including:
pooling mortgage contracts to diversify individual longevity risks;
providing a mechanism to source mortgage contracts with promise of future income stream (general) while eliminating or minimizing compounding interest;
using mortgage backed commitment to pay at future date as alternate to cash premium in the ILRI structure;
methods and systems to manage the mortgage and cash pools within the same structure;
mortgage contracts that charge minimal or no time based interest and are optimized to meet specific cashflow requirements when pooled;
creating long-term, CPI-linked longevity hedge instruments by pooling retail investor mortgage contracts;
a hedge instrument as above, but credit enhanced by longevity pool to be an exact deferred annuity hedge; and
a hedge instrument as above, but including mechanism to tailor mortgage contracts and securitization structuring to meet specific liability profiles requested by a Life company

### Generalised Case

It is also noted that the efficient transparent pooling arrangement may also be used to provide other forms of insurance, where a group of customers is prepared to ‘own’ the systematic risk rather than ‘sell’ it to an insurance company. If the group retains this risk it gives up dollar-certainty on the level of income payment, but will often achieve a higher expected pay-out per dollar of premium since the guarantee margin can be eliminated. This “Group-Self-Insurance” may be applied to car insurance, home and contents insurance etc. The following Table illustrates how the general insurance implementation may be correlated to the specific ILRI implementations described above.

TABLE
Comparison between ILRI example and general insurance case

| General Insurance Case | ILRI Example |
|---|---|
| Investors exposed to risk have | Investors are classified by sex, |
| their risk exposure classified | age, reversionary status - may also |
| (underwritten) in some way | include more detailed underwriting |
| Investors decide how much cover | Investor decides survival age and |
| they want and terms such as de- | target level of income after |
| ductibles - adviser lets them | survival age |
| know how much they must invest | |
| based on quoting engine which | |
| looks at risk added to a pool | |
| by investors and the number of | |
| investors in the pool | |
| Investors decide how they want | Investors decide how they want their |
| their money invested | money invested |
| If the insured event happens, | If investor dies, or reaches survival |
| then the pay-out is drawn from | age, benefits are paid out, drawing |
| all accounts in proportion to a | down on the total value of the pool - |
| risk statistic (more is drawn | however in ILRI longevity bonuses |
| from those with a greater risk | are added as contrasted to this |
| of having an insured event and | example where claim premium |
| in proportion to the $ coverage | deductions are made |
| they want) | |
| While an investor has value | While the investor has funds at |
| above a certain reserve in the | risk they get credited with bonuses |
| account, they are covered to | |
| the specified level of risk. | |
| The investor loses their right | |
| to coverage if they don't | |
| maintain sufficient funds at risk | |
| When account balances fall below | Coverage is maintained by adding |
| a certain point (due to investment | additional funds as required |
| performance or claims draw- | |
| downs) the investor is called on to | |
| make an additional contribution | |
| If the investor wishes to with- | Investor can withdraw surrender |
| draw at any point, they can cash | value |
| their entire current account value | |
| Extreme event reinsurance may be | Since payments are linked to the |
| added to ensure that the product | income from the pool, viability |
| is always viable | is ensured |

A primary benefit of the general arrangement is that the investor can eliminate the underwriting profit and investment profit that would typically accrue to the insurance company. The investor would therefore pay standard funds management costs and insurance operations costs (which would have been included into a traditional insurance premium anyway). There is also an opportunity to keep the level of capital invested as close to the reserve level as possible by frequently topping up the reserve on an as-needed basis. These cost savings may be very attractive, particularly to business clients, for example with professional indemnity insurance. It is also be possible to pool together many different types of insurance risk into the same pool through the value of a risk metric, and this can reduce the cost of the extreme event reinsurance.

### INDUSTRIAL APPLICABILITY

The arrangements described are applicable, at least, to the financial services industry. Extension of the arrangements described into general insurance make the present disclosure applicable to almost all industries.

The foregoing describes only some embodiments of the present invention, and modifications and/or changes can be made thereto without departing from the scope and spirit of the invention, the embodiments being illustrative and not restrictive.

(Australia Only) In the context of this specification, the word “comprising” means “including principally but not necessarily solely” or “having” or “including”, and not “consisting only of”. Variations of the word “comprising”, such as “comprise” and “comprises” have correspondingly varied meanings.

1. A method of providing financial payments to investors who live longer than a specified survival age, said method comprising the steps of:
(a) receiving premium payments from a plurality of investors;
(b) establishing, for each investor, a corresponding survival age;
(c) investing the premium payments to form an investment pool for the investors;
(d) maintaining an account that quantifies a respective notional share of the investment pool for each of the investors;
(e) distributing, if an investor dies, a proportion of the deceased investor's notional share in the investment pool to the shares of surviving investors of the investment pool; and
(f) checking whether a surviving investor is older than the surviving investor's established survival age and, if so, paying a survival benefit to the surviving investor, said 15 survival benefit being based upon at least a value of the investment pool.

2. A method according to claim 1 wherein step (f) comprises paying the survival benefit as at least one of (i) an annuity, and/or (ii) a lump sum and/or (iii) an account-based retirement income product

3. A method according to claim 2 wherein the annuity and/or account-based retirement income product has residual capital value which is either (i) zero or (ii) significantly less than the annuity and/or account-based retirement income product purchase value.

4. A method according to claim 1 wherein the survival benefit is further based upon at least one of projected investment returns, projected pool expenses and taxes, the projected mortality of the investors in the pool, and terms governing the survival benefits.

5. A method according to claim 1 wherein step (f) further comprises performing the steps of:
(f)(1) periodically determining a portion of the surviving investor's share of the investment pool to issue as a survival benefit for a payment period; and
(f)(2) providing the survival benefit for the surviving investor.

6. A method according to claim 5 wherein said step {f)(1) determines the portion to issue to a surviving investor as a survival benefit based on factors selected from the group consisting of:
a value of the surviving investor's notional share of the investment pool; a projection of future market returns for the investment pool;
a projection of future group mortality for investors in the investment pool; and a projection of future benefits due to investors in the investment pool.

7. A method according to claim 6 wherein the future returns include at least market returns adjusted according to any combination of fees, taxes and expenses.

8. A method according to claim 1 wherein step (f) comprises updating an actuarial mortality table used to project future mortality to reflect a mortality history of investors in the investment pool.

9. A method according to claim 8 wherein step (f)(1) comprises an equitable determination of survival benefit for the surviving investor in comparison to other investors associated with the pool.

10. A method according to claim 9 said method being subject to the constraint that the pool must retain sufficient capital to support projected future distributions at the same (i) nominal level, or (ii) real level with a specified level of certainty.

11. A method according to claim 9 wherein the equitable determination is performed using a numerical modelling of projected future cashflows to and from the investment pool.

12. A method according to claim 9 wherein step (f)(1) comprises the sub-steps of:
(f)(1)(i) determining a current notional account balance for the investors;
(f)(I)(ii) modelling, using the actuarial mortality table, an expected distribution of 20 future equitable survival benefit cashflows to be provided to the investors, based on an assumed current survival benefit;
(f)(I)(iii) modelling an expected distribution of future death benefit cashflows to deceased investors and redemption value cashflows to future lapsing members;
(f)(1)(iv) modelling an expected distribution of management fee, expense and tax cashflows to be deducted from the pool;
(f)(I)(v) modelling according to specified assumptions, future cashflows generated from future investment growth given an investment option associated with the 5 pool and selected by the investor;
(f)(1)(vi) calculating, using the values obtained in steps (f)(1)(i)-(f)(1)(v), a distribution of total project future cashflows into and out of the investment pool; and
(f)(1)(vii) iterating to maximise the assumed current survival benefit value in step f(1)(ii) subject to the constraint that the pool has sufficient capital to support all distributions to some specified level of certainty.
